(19) United States
(12) Patent Application Publication
(10) Pub. No.: US 2003/0236961 A1
(43) Pub. Date: Dec. 25, 2003

(54) Systems and methods for management of memory in information delivery environments

(76) Inventors: Chaoxin C. Qiu, Austin, TX (US); Mark J. Conrad, Colorado Springs, CO (US); Scott C. Johnson, Round Rock, TX (US); Theodore S. Webb, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 09/797,201

(22) Filed: Mar. 1, 2001

Related U.S. Application Data
(60) Provisional application No. 60/246,359, filed on Nov. 7, 2000.
(60) Provisional application No. 60/246,445, filed on Nov. 7, 2000.

(51) Int. Cl. G06F 12/00

(52) U.S. Cl. 711/170; 711/158; 711/118; 711/138; 711/136

(57) ABSTRACT

Memory managements systems and methods that may be employed, for example, to provide efficient management of memory for network systems. The disclosed systems and methods may consider cost-benefit trade-off between the cache value of a particular memory unit versus the cost of caching the memory unit and may utilize a multi-layer queue management structure to manage buffer/cache memory in an integrated fashion. The disclosed systems and methods may be implemented as part of an information management system, such as a network proceessing system that is operable to process over-size data objects communicated via a network environment, and that may include a network processor operable to process network-communicated information and a memory management-system operable to manage disposition of individual memory units of over-size data objects based upon one or more parameters, such as one or more parameters reflecting the cost and value associated with maintaining the information in integrated buffer/cache memory.

This application claims priority from Provisional Application Serial No. 60/246,359 filed on Nov. 7, 2000 which is entitled “CACHING ALGORITHM FOR MULTIMEDIA SERVERS” and to Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS,” the disclosures of each being incorporated herein by reference.

### BACKGROUND OF THE INVENTION

The present invention relates generally to information management, and more particularly, to management of memory in network system environments.

In information system environments, files are typically stored by external large capacity storage devices, such as storage disks of a storage area network (“SAN”). Due to the large number of files typically stored on such devices, access to any particular file may be a relatively time consuming process. However, distribution of file requests often favors a small subset of the total files referenced by the system. In an attempt to improve speed and efficiency of responses to file requests, cache memory schemes, typically algorithms, have been developed to store some portion of the more heavily requested files in a memory form that is quickly accessible to a computer microprocessor, for example, random access memory (“RAM”). When cache memory is so provided, a microprocessor may access cache memory first to locate a requested file, before taking the processing time to retrieve the file from larger capacity external storage. In this manner, processing time may be conserved by reducing the amount of data that must be read from external and larger portions of memory. “Hit Ratio” and “Byte Hit Ratio” are two indices commonly employed to evaluate the performance of a caching algorithm. The hit ratio is a measure of how many of the file requests can be served from the cache and the byte hit ratio is a measure of how many bytes of total outgoing data flow can be served from the cache.

Hard disk drives have considerably higher storage capacity and lower unit price than cache memory. Therefore cache memory size, e.g., for an file server, should be carefully balanced between the cost of the memory and the incremental improvement to the cache hit ratio provided by additional memory. One generally accepted rule of thumb is that cache memory size should be at least 0.1 to 0.3% of storage size in order to see a tangible benefit. Most manufacturers today support a configurable cache memory size up to 1% of the storage size for traditional file system cache memory design.

Given the relative high cost associated with large amounts of cache memory, a number of solutions for offsetting this cost and maximizing utilization of cache memory have been proposed. For example, some present cache designs include deploying one or more computational algorithms for storing and updating cache memory. Many of these designs seek to implement a replacement policy that removes “cold” files and retains “hot” files. In the case of streaming multimedia data delivery in particular, it has been found that the relative probability of a file being referenced may also be correlated to the popularity rank of the file. For example, in the delivery of streaming video by streaming video servers, viewers tend to concentrate on particular popular movies. However, in continuous media data delivery environments, the size of a movie file may be extremely large (e.g., about 1 GB or larger) in relation to the size of the buffer/cache memory (e.g., from about 1 GB to about 4 GB), making undesirable the use of traditional data caching algorithms, which tend to rank all blocks belonging to a file the same priority level and thus, to cache or replace the whole file. This characteristic has led to the development of caching algorithms in an specific attempt to improve streaming multimedia system performance.

One type of caching algorithm developed for multimedia applications is known as MRU (“Most-Recently-Used first”). An MRU algorithm chooses the most recently used blocks as the candidates for replacement. Variations on the MRU type algorithm include SIZE-MRU and SpaceXAge algorithms. However, these types of algorithms don't take into consideration that some continuously delivered data may have multiple existing viewers, and that data used by one viewer may be re-used by an existing succeeding viewer.

In an attempt to consider data re-usability by succeeding viewers, algorithms such as BASIC, DISTANCE, IBM Interval Caching, and GIC have been developed. For example, the IBM Interval Caching algorithm operates by taking into consideration whether or not there exists a succeeding viewer who will re-use the data, and if so, what interval size exists between the current and succeeding user (i.e., number of data blocks between a pair of consecutive viewers). The replacement policy of the Interval Caching algorithm chooses those blocks that belong to the largest such interval for replacement. One drawback of these types of algorithms is that the replacement policy may adversely impact I/O scheduling. For example, when a set of data blocks belonging to an interval is replaced, a succeeding viewer may experience a “hiccup” or disruption in the continuity of data flow if the disk controller doesn't have resources to support the succeeding viewer.

Still other types of algorithms have been employed that consider the access pattern to multimedia data, such as by calculating the average request arrival rate and disk utilization. In one example, existing streams may be partitioned into multiple classes based on a set of predefined marginal checkpoints on the average arrival rate level. In determining which data block to be replaced, such an algorithm takes into account the disk utilization and the average request arrival rate to the multimedia object to which the block belongs. However, this type of algorithm requires a large computational overhead.

### SUMMARY OF THE INVENTION

Disclosed herein are systems and methods for memory management in over-size data object delivery environments that are relatively simple and easy to deploy and that offer reduced computational overhead for managing extremely large numbers of files relative to traditional memory management practices. The disclosed systems and methods may be advantageously implemented in the delivery of over-size data objects such as continuous streaming media data files and very large non-continuous data files, including in such environments as streaming multimedia servers or web proxy caching for streaming multimedia files, Also disclosed are memory management algorithms that are effective, high performance and which have low operational cost so that they may be implemented in a variety of memory management environments, including high-end streaming servers.

Using the disclosed algorithms, buffer, cache and free pool memory may be managed together in an integrated fashion and used more effectively to improve system throughput. The disclosed memory management algorithms may also be employed to offer better streaming cache performance in terms of total number of streams a system can support, improvement in streaming system throughput, and better streaming quality in terms of reducing or substantially eliminating hiccups encountered during active streaming.

Advantages of the disclosed systems and methods may be achieved by employing an integrated block/buffer logical management structure that includes at least two layers of a configurable number of multiple memory queues (e.g., at least one buffer layer and at least one cache layer). A two-dimensional positioning algorithm for memory units in the memory may be used to reflect the relative priorities of a memory unit in the memory in terms of both recency and frequency. For example, the algorithm may employ horizontal inter-queue positioning (i.e., the relative level of the current queue within a multiple memory queue hierarchy) to reflect popularity of a memory unit (or reference frequency), and vertical intra-queue positioning (i.e., the relative level of a memory unit within each memory queue) to reflect (augmented) recency of a memory unit.

The integrated block/buffer management structure may be implemented to provide improved cache management efficiency in streaming information delivery environments with reduced computational requirements, including better cache performance in terms of hit ratio and byte hit ratio, especially in the case of small cache memory. This surprising performance is made possible, in part, by the use of natural movement of memory units in the chained memory queues to resolve the aging problem in a cache system.

Further, the disclosed algorithms may be employed to advantageously differentiate the value for cached blocks within a movie, so that only most useful or valuable portions of the movie are cached. The unique integrated design of the streaming management algorithms disclosed herein may be implemented to allow a block/buffer manager to track frequency of memory unit reference (e.g., one or more requests for access to a memory unit) consistently for memory units that are either in-use (i.e., in buffer state) or in-retain stage (i.e., in cache state) without additional computational overhead. The design takes advantage of the fact that access to a continuous media file is sequential and in order, and considers the value of caching each memory unit, e.g., in terms of I/O savings realized when other viewers access the same unit and how soon an immediately following viewer is going to reuse the same unit based on the memory unit consumption rate of the succeeding viewer.

Taking advantage of the above-described cache value differentiation method, the disclosed algorithms may be implemented in a manner that advantageously considers costbenefit trade-off between the cache value of a particular memory unit (e.g., I/O savings that can be realized when the memory unit is cached, and difference in viewing rate/memory unit access time between sequential viewers) versus the cost of caching the memory unit (e.g., byte-seconds consumed by the memory unit while in cache memory). This capability is both significant and advantageous, and is not possible with conventional caching algorithms that only consider the size of the interval between successive viewers of streaming media data.

Using the disclosed integrated memory management structures, significant savings in computational resources may be realized by virtue of the fact that frequency of reference and aging are factored into a memory management algorithm via the chain depth of memory queues (“K”), thus avoiding tracking of reference count, explicit aging of reference count, and sorting of the reference order. Furthermore, memory unit movement in the logical management structure may be configured to involve simple identifier manipulation, such as manipulation of pointers, indices etc. Thus, the disclosed integrated memory management structures may be advantageously implemented to allow control of cache management computational overhead in, for example, the O(1) scale, which will not increment along with the size of the managed cache/buffer memory.

In one particular embodiment, disclosed is a layered multiple LRU (LMLRU) algorithm for use with multimedia servers that employs an integrated block/buffer management structure including two or more layers of a configurable number of multiple LRU queues and a two-dimensional positioning algorithm for data blocks in the memory to reflect the relative priorities of a data block in the memory in terms of both recency and frequency. Horizontal inter-LRU queue position (i.e., the relative position among all LRU queues) may be used to reflect a data block's cache value, and a set of cost scales may be defined to augment data block positioning in order to reflect the cost of a cached block in the memory, in terms of how long it will take before a cached block is re-used and how many blocks will occupy the memory. A pro-active block replacement algorithm may be employed to prevent resource starvation that may occur due to cache/buffer contention, and admission control rules may be defined to ensure that the block replacement algorithm operates in a manner that avoids “hiccups” to succeeding viewers. Natural movement of blocks in the LRU queues may be taken advantage of in order to identify cache replacement candidates.

As previously mentioned, block movement in a given queue may be configured to simply involve manipulation of identifiers such as pointers, indices, etc. The popularity of continuous media data (e.g., a_streaming movie) and the cost of caching a data block may be factored into the algorithm via the disclosed cache/buffer structures. No aging issue is involved because popularity is counted based on existing viewers, thus avoiding necessity of tracking reference count, explicit aging of reference count, and the sorting of the reference order. Caching replacement may be performed at an interval level and the algorithm may be implemented so that the replaced interval will not be cached again until the life of the interval ends. This implementation advantageously reduces the processing workload of the cache manager and I/O admission control process, which is driven by events that change the state of a viewer. Thus, the disclosed algorithms and management structures advantageously allow system scalability to be achieved.

In one respect then, disclosed is a method of managing memory units, the method including assigning a memory unit of an over-size data object to one of two or more memory positions based on a status of at least one first memory parameter that reflects the number of anticipated future requests for access to the memory unit, the elapsed time until receipt of a future request for access to the memory unit, or a combination thereof.

In another respect, disclosed is a method of managing memory units within an information delivery environment, including assigning a memory unit of an over-size data object to one of a plurality of memory positions based on a status of at least one first memory parameter and a status of at least one second memory parameter; the first memory parameter reflecting the number of anticipated future requests for access to the memory unit, the elapsed time until receipt of a future request for access to the memory unit, or a combination thereof; and the second memory parameter reflecting the number of memory units existing in the data interval between an existing viewer of the memory unit and a succeeding viewer of the memory unit, the difference in data consumption rate between the existing viewer and the succeeding viewer of the memory unit, or a combination thereof.

In another respect, disclosed is a method of managing memory units using an integrated memory management structure, the method including assigning memory units of an over-size data object to one or more positions within a buffer memory defined by the integrated structure; subsequently reassigning the memory units from the buffer memory to one or more positions within a cache memory defined by the structure or to a free pool memory defined by the structure; and subsequently removing the memory units from assignment to a position within the free pool memory; wherein the reassignment of the memory units from the buffer memory to one or more positions within the cache memory is based on the combination of at least one first memory parameter and at least one second memory parameter, wherein the first memory parameter reflects the value of maintaining the memory units within the cache memory in terms of future external storage I/O requests that may be eliminated by maintaining the memory units in the cache memory, and wherein the second memory parameter reflects cost of maintaining the memory units within the cache memory in terms of the size of the memory units and duration of storage associated with maintaining the memory units within the cache memory.

In another respect, disclosed is a method of managing memory units of an over-size data object using a multi-dimensional logical memory management structure that may include two or more spatially-offset organizational sub-structures, such as two or more spatially-offset rows, columns, layers, queues, combinations thereof, etc. Each spatially-offset organizational substructure may include one position, or may alternatively be subdivided into two or more positions within the substructure that may be further organized within the substructure, for example, in a sequentially ascending manner, sequentially descending manner, or using any other desired ordering manner. Such organizational sub-structures may be spatially offset in symmetric or asymmetric spatial relationship, and in a manner that forms, for example, a two-dimensional or three-dimensional management structure. In one possible implementation of the disclosed multi-dimensional memory management structures, memory units of an over-size data object may be assigned or reassigned in any suitable manner between positions located in different organizational sub-structures, between positions located within the same organizational sub-structure, combinations thereof, etc. Using the disclosed multi-dimensional memory management logical structures advantageously allows the changing value or status of a given memory unit in terms of multiple memory state parameters, and relative to other memory units within a given structure, to be tracked or otherwise followed or maintained with greatly reduced computational requirements, e.g., in terms of calculation, sorting, recording, etc.

For example, in one exemplary application of a multi-dimensional memory management structure as described above, reassignment of a memory unit of an over-size data object from a first position to a second position within the structure may be based on relative positioning of the first position within the structure and on two or more parameters, and the relative positioning of the second position within the structure may reflect a renewed or updated combined cache value of the memory unit relative to other memory units in the structure in terms of the two or more parameters. Advantageously, vertical and horizontal assignments and reassignments of a memory unit within a two-dimensional structure embodiment of the algorithm may be employed to provide continuous mapping of a relative positioning of the memory unit that reflects a continuously updated combined cache value of the memory unit relative to other memory units in the structure in terms of the two or more parameters without requiring individual values of the two or more parameters to be explicitly recorded and recalculated. Such vertical and horizontal assignments also may be implemented to provide removal of memory units having the least combined cache value relative to other memory units in the structure in terms of the two or more parameters, without requiring individual values of the two or more parameters to be explicitly recalculated and resorted.

In another respect, disclosed is a method of managing memory units using an integrated two-dimensional logical memory management structure, including: providing a first horizontal buffer memory layer including two or more sequentially ascending buffer memory positions; providing a first horizontal cache memory layer including one or more sequentially ascending cache memory positions and a lowermost memory position that includes a free pool memory position, the first horizontal cache memory layer being vertically offset from the first horizontal buffer memory layer; horizontally assigning and reassigning memory units of an over-size data object between the buffer memory positions within the first horizontal buffer memory layer based on at least one first memory parameter; horizontally assigning and reassigning memory units of an over-size data object between the cache memory positions and between the free pool memory position within the first horizontal cache memory layer based on at least one second memory parameter; and vertically assigning and reassigning memory units of an over-size data object between the first horizontal buffer memory layer and the first horizontal cache memory layer based on at least one third memory parameter.

In another respect, disclosed is an integrated two-dimensional logical memory management structure for use in managing memory units of over-size data objects, including at least one horizontal buffer memory layer including two or more sequentially ascending continuous media data buffer memory positions; and at least one horizontal cache memory layer including one or more sequentially ascending over-size data object memory unit cache memory positions and a lowermost memory position that includes an over-size data object memory unit free pool memory position, the first horizontal cache memory layer being vertically offset from the first horizontal buffer memory layer.

In another respect, disclosed is a network processing system operable to process over-size object data communicated via a network environment. The system may include a network processor operable to process network-communicated information and a memory management system operable to reference the over-size object data based upon one or more parameters, such as one or more parameters reflecting the cost associated with maintaining the information in integrated buffer/cache memory.

### BRIEF DESCRIPTION OF THE DRAWINGS

FIG. 1 illustrates a memory management structure according to another embodiment of the disclosed methods and systems.

FIG. 2(a) illustrates a sequence of memory blocks that represents a movie being viewed by five sequential viewers according to one embodiment of the disclosed methods and systems.

FIG. 2(b) illustrates a sequence of memory blocks that represents another movie being viewed by three sequential viewers according to one embodiment of the disclosed methods and systems.

FIG. 2(c) illustrates a sequence of memory blocks that represents a movie being viewed by two sequential viewers according to one embodiment of the disclosed methods and systems.

FIG. 3 illustrates a memory management structure and memory block assignment therein according to one embodiment of the disclosed methods and systems.

FIG. 4 illustrates a memory management structure and memory block assignment therein according to one embodiment of the disclosed methods and systems.

FIG. 5 illustrates a memory management structure and memory block assigmnment therein according to one embodiment of the disclosed methods and systems.

FIG. 6 illustrates a memory management structure and memory block assignment therein according to one embodiment of the disclosed methods and systems.

FIG. 7 illustrates a memory management structure and memory block assignment therein according to one embodiment of the disclosed methods and systems.

FIG. 8(a) illustrates a sequence of memory blocks that represents a movie being viewed by five sequential viewers according to one embodiment of the disclosed methods and systems.

FIG. 8(b) illustrates a sequence of memory blocks that represents another movie being viewed by five sequential viewers according to one embodiment of the disclosed methods and systems.

FIG. 9 illustrates a memory management structure and memory block assignment therein according to one embodiment of the disclosed methods and systems.

FIG. 10 illustrates a sequence of memory blocks that represents a movie being viewed by five sequential viewers according to one embodiment of the disclosed methods and systems.

FIG. 11 illustrates a memory management structure and memory block assignment therein according to one embodiment of the disclosed methods and systems.

### DESCRIPTION OF ILLUSTRATIVE EMBODIMENTS

Disclosed herein are two dimensional methods and systems for managing memory that employ multiple-position layers (e.g., layers of multiple queues, multiple cells, etc.) and that may be advantageously implemented with a variety of types of information management systems, including network content delivery systems that deliver continuous streaming content (e.g., streaming video, streaming audio, web proxy cache for Internet streaming, etc.) and/or that deliver over-size or very large data objects of any other kind, such as over-size non-continuous data objects. By using a two-dimensional approach, particular memory units may be characterized, tracked and managed based on multiple parameters associated with each memory unit. Using multiple and interactive layers of configurable queues allows memory units to be efficiently assigned/reassigned between queues of different memory layers, e.g., between a buffer layer and a cache layer, based on multiple parameters.

The disclosed methods and systems may be implemented to manage memory units stored in any type of memory storage device or group of such devices suitable for providing storage and access to such memory units by, for example, a network, one or more processing engines or modules, storage and I/O subsystems in a file server, etc. Examples of suitable memory storage devices include, but are not limited to (“RAM”), disk storage, I/O subsystem, file system, operating system or combinations thereof. Similarly, memory units may be organized and referenced within a given memory storage device or group of such devices using any method suitable for organizing and managing memory units. For example, a memory identifier, such as a pointer or index, may be associated with a memory unit and “mapped” to the particular physical memory location in the storage device (e.g. first node of Q₁^{used}=location FF00 in physical memory). In such an embodiment, a memory identifier of a particular memory unit may be assigned/reassigned within and between various layer and queue locations without actually changing the physical location of the memory unit in the storage media or device. Further, memory units, or portions thereof, may be located in non-contiguous areas of the storage memory. However, it will be understood that in other embodiments memory management techniques that use contiguous areas of storage memory and/or that employ physical movement of memory units between locations in a storage device or group of such devices may also be employed.

For illustration purposes, exemplary embodiments described herein relate to use of the disclosed methods and systems in continuous media data delivery embodiments. However, it will be understood with benefit of this disclosure that the disclosed systems and methods may also be advantageously implemented in information management environments where over-size data objects of any kind are managed or delivered. As used herein an “over-size data object” refers to a data object that has an object size that is so large relative to the available buffer/cache memory size of a given information management system, that caching of the entire data object is not possible or is not allowed by policy within the given system. Examples of non-continuous over-size data objects include, but are not limited to, relatively large FTP files, etc.

Examples of memory parameters that may be considered in the practice of the disclosed methods and systems include any parameter that at least partially characterizes one or more aspects of a particular memory unit including, but not limited to, parameters such as recency, frequency, aging time, sitting time, size, fetch (cost), operator-assigned priority keys, status of active connections or requests for a memory unit, etc. Parameters specifically related to characteristics of continuous media data or over-size data object delivery may also be employed. Examples of such parameters include, but are not limited to, memory unit popularity (e.g., as measured by the number of existing viewers that will use a particular memory unit), interval size (e.g., as measured by the number of memory units between successive viewers of a particular memory unit), media data delivery rate (e.g., individual memory unit consumption rate for each viewer), interval time length (e.g., as measured by the time interval between successive viewers of a particular memory unit), etc. Furthermore, two or more of such parameters may be considered in combination. For example, interval size and interval time length may factored together to obtain a measure of cache resource cost associated with a particular memory unit. Further, status of a memory parameter/s may be expressed using any suitable value that relates directly or indirectly to the condition or value of a given memory parameter.

With regard to these parameters, recency (e.g. of a file reference) relates to locality in terms of current trend of memory unit reference and includes, for example, least-recently-used (“LRU”) cache replacement policies. Frequency (e.g. of a file reference) relates to locality in terms of historical trend of memory unit reference, and may be employed to compliment measurements of recency. Aging is a measurement of time passage since a memory unit was last referenced, and relates to how “hot” or “cold” a particular memory unit currently is. Sitting time (“ST”) is a measurement of how long a particular memory unit has been in place at a particular location within a caching/buffering structure, and may be controlled to regulate frequency of memory unit movement within a buffer/caching queue. Size of memory unit is a measurement of the amount of buffer/cache memory that is consumed to maintain a given referenced memory unit in the buffer or cache, and affects the capacity for storing other memory units, including smaller frequently referenced memory units.

The disclosed methods and systems may utilize individual memory positions, such as memory queues or other memory organizational units, that may be internally organized based on one or more memory parameters such as those listed above. In the case of memory queues, examples of suitable intra-queue organization schemes include, but are not limited to, least recently used (“LRU”), most recently used (“MRU”), least frequently used (“LFU”), etc. Memory queues may be further organized in relation to each other using two or more layers of queues based on one or more other parameters, such as status of requests for access to a memory unit, priority class of request for access to a memory unit (e.g., based on Quality of Service (“QoS”) parameters, Service Level Agreement (“SLA”) parameter), etc. Within each queue layer, multiple queues may be provided and organized in an intra-layer hierarchy based on additional parameters, such as frequency of access, etc. Dynamic reassignment of a given memory unit within and between queues, as well as between layers, may be effected based on parameter values associated with the given memory unit, and/or based on the relative values of such parameters in comparison with other memory units.

The provision of multiple queues, and layers of multiple queues, provides a two-dimensional logical memory management structure capable of assigning and reassigning memory in consideration of multiple parameters, increasing efficiency of the memory management process. The capability of tracking and considering multiple parameters on a two-dimensional basis also makes possible the integrated management of individual types of memory (e.g., buffer memory, cache memory and/or free pool memory), that are normally managed separately.

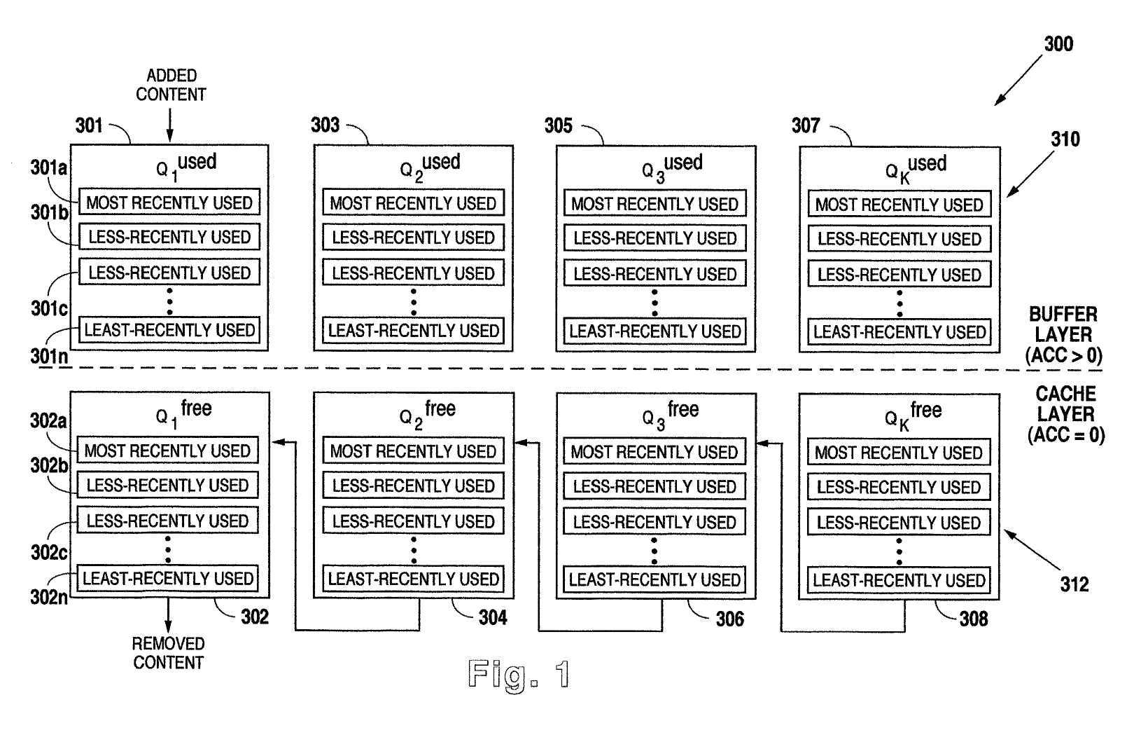

FIG. 1 illustrates an exemplary embodiment of logical structure 300 that may be employed to manage memory units within a memory device or group of such devices, for example, using an algorithm and based on one or more parameters as described elsewhere herein. As such, logical structure 300 should not be viewed to define a physical structure of a memory device or memory locations, but as a logical methodology for managing content or information stored within a memory device or a group of memory devices. Further, although described herein in relation to block level memory, it will be understood that embodiments of the disclosed methods and system may be implemented to manage memory units on virtually any memory level scale including, but not limited to, file level units, bytes, bits, sector, segment of a file, etc. However, management of memory on a block level basis instead of a file level basis may present advantages for particular memory management applications, by reducing the computational complexity that may be incurred when manipulating relatively large files and files of varying size. In addition, block level management may facilitate a more uniform approach to the simultaneous management of files of differing type such as HTTP/FTP and video streaming files.

FIG. 1 illustrates one exemplary embodiment of a possible memory management logical structure embodiment 300 that includes two layers 310 and 312 of queues linked together with multiple queues in each layer. In this regard, memory management logical structure employs two horizontal queue layers 310 and 312, between which memory may be vertically reassigned. Buffer layer 310 is provided with buffer memory queues 301, 303, 305 and 307. Cache layer 310 is provided with cache memory queues 302, 304, 306 and 308.

It will be understood that FIG. 1 is a simplified representation that includes four queues per layer for purpose of illustrating vertical reassignment of memory units between layers 310 and 312 according to one parameter (e.g., status of request for access to the memory unit), and vertical ordering of memory units within queues 301 and 302 according to another parameter (e.g., recency of last request). However, as described further herein two or more multiple queues i may be provided for each given layer to enable horizontal reassignment of memory units between queues based on an additional parameter (e.g., number of succeeding viewers for a given memory unit).

In the embodiment illustrated in FIG. 1, first layer 310 is a buffer management structure that has multiple buffer queues 301, 303, 305 and 307 (i.e., Q₁^{used}. . . Q_{K}^{used}) representing used memory, or memory currently being accessed by one or more active connections. Second layer 312 is a cache management structure that has multiple cache queues 304, 306 and 308 (i.e., Q₂^{free}. . . Q_{K}^{free}) and one cache layer queue 302 that may be characterized as a free pool queue (i.e., Q₁^{free}), representing cache memory, or memory that was previously accessed, but is now free and no longer associated with an active connection. As will be described further herein, a memory unit (e.g., memory block) may be added to layer 310 (e.g., at the top of Q₁^{used}), vertically reassigned between various queues within layers 310 and 312 in either direction, and may be removed from layer 310, (e.g., at the bottom of Q₁^{free}). For illustration purposes, an exemplary embodiment employing memory blocks will be further discussed in relation to the figures, although as mentioned above it will be understood that other types of memory units may be employed.

As illustrated in FIG. 1, each of the buffer and cache layer queues are LRU queues. For example, Q₁^{used} buffer queue 301 includes a plurality of nodes 301a, 301b, 301c, . . . 301n that may represent, for example, units of content stored in memory in an LRU organization scheme (e.g., memory blocks, etc.). For example, Q₁^{used} buffer queue 301 may include a most-recently used 301a unit, a less-recently used 301b unit, a less-recently used 301c unit, and a least-recently used 301n unit that all represent a memory unit that is currently associated with one or more active connections. In a similar manner, Q₁^{free} cache queue 302 includes a plurality of memory blocks which may include a most-recently used 302a unit, a less-recently used 302b unit, a less-recently used 302c unit, and a least-recently used 302n unit. Although LRU queues are illustrated in FIG. 1, it will be understood that other types of queue organization may be employed, for example, MRU, LFU, FIFO, etc.

Although not illustrated, it will be understood that individual queues, e.g., such as Q₁^{used} memory 301 and Q₁^{free} memory 302, may include additional or fewer memory blocks, i.e., n represents the total number of memory blocks in a queue, and may be any number greater than or equal to one based on the particular needs of a given memory management application environment. In addition, the total number of memory blocks (n) employed per queue need not be the same, and may vary from queue to queue as desired to fit the needs of a given application environment.

Using memory management logical structure 300, memory blocks may be managed (e.g. assigned, reassigned, copied, replaced, referenced, accessed, maintained, stored, etc.) within and between memory queues Q₁^{used} Q_{K}^{used} and within and between memory queues Q₁^{free}. . . Q_{K}^{free}, as well as between buffer memory layer 310 and free memory layer 312 using an algorithm that considers one or more of the parameters previously described. For example, relative vertical position of individual memory blocks within each memory queue may be based on recency, using an LRU organization as follows. A memory block may originate in an external high capacity storage device, such as a hard drive. Upon a request for access to the memory block by a network or processing module, it may be copied from the external storage device and added to the Q₁^{used} memory queue 301 as most recently used memory block 301a , vertically supplanting the previously most-used memory block which now takes on the status of less-recently used memory block 301b as shown. Each successive memory block within used memory queue 301 is vertically supplanted in the same manner by the next more recently used memory block. It will be understood that a request for access to a given memory block may include a request for a larger memory unit (e.g., file) that includes the given memory block.

When all requests for access to a memory block are completed or closed, so that a memory block is no longer the subject of an active request, the memory block may be vertically reassigned from buffer memory layer 310 to free cache memory layer 312. This may be accomplished, for example, by reassigning the memory block from the Q₁^{used} memory queue 301 to the top of Q₁^{free} memory queue 302 as most recently used memory block 302a, vertically supplanting the previously most-used memory block which now takes on the status of lessrecently used memory block 302b as shown. Each successive memory block within Q₁^{free} memory queue 302 is vertically supplanted in the same manner by the next more recently used memory block, and the least recently used memory block 302n is vertically supplanted and removed from the bottom of Q₁^{free} free pool memory queue 302, for example, when additional memory is required for assignments of new memory blocks to queues within buffer layer 310.

With regard to block replacement in individual queues, a memory queue may be fixed, so that removal of a bottom block in the queue automatically occurs when the memory queue is full and a new block is reassigned from another buffer or cache layer queue to the memory queue. For example, when cache queues 304, 306 and 308 are provisioned as fixed-size queues and are full with memory blocks, the bottom block of each such fixed-sized cache queue is supplanted and reassigned to the next lower queue when another memory block is reassigned to the top of the queue as indicated by the arrows in FIG. 1.

Alternatively, an individual memory queue may be flexible in size and the removal of a bottom block in the queue may occur only, for example, only upon a trigger event. For example, a block may be maintained in a flexible buffer layer queue as long as it is the subject of an active request for access, and only reassigned to a cache layer queue upon closure of all such active requests. A block may be maintained in a flexible free pool cache layer queue 302 (Q₁^{free}), for example, until the buffer/cache memory is full and additional memory space is required in buffer/cache storage to make room for the assignment of a new block 301a to the top of Q₁^{used} memory queue 301 from external storage. It will be understood that these represent just two possible replacement policies that may be implemented and that other alternate replacement policies are also possible to accomplish removal of memory blocks from Q₁^{free} memory queue 302. As will be described further herein, one embodiment disclosed herein may employ flexible sized buffer queues 301, 303, 305 and 707 in combination with fixed-sized cache queues 304, 306 and 308, and a flexible-sized free pool queue 302.

In the illustrated embodiment, memory blocks may be vertically managed (e.g., assigned and reassigned between cache layer 312 and buffer layer 310 in the manner described above) using any algorithm or other method suitable for logically tracking the connection status (i.e., whether or not a memory blocks is currently being accessed). For example, a variable or parameter may be associated with a given block to identify the number of active network locations requesting access to the memory block, or to a larger memory unit that includes the memory block. Using such a parameter, memory blocks may be vertically managed based upon the number of open or current requests for a given block, with blocks currently accessed being assigned to buffer layer 310, and then reassigned to cache layer 312 when access is discontinued or closed.

To illustrate, in one embodiment an integer parameter (“ACC”) representing the active connection count may be associated with each memory block maintained in the memory layers of logical structure 300. The value of ACC may be set to reflect the total number of access connections currently open and transmitting, or otherwise actively using or requesting the contents of the memory block. Memory blocks may be managed by an algorithm using the changing ACC values of the individual blocks. For example, when an unused block in external storage is requested or otherwise accessed by a single connection, the ACC value of the block may be set at one and the block assigned or added to the top of Q₁^{used} memory 301 as most recently used block 301a. As each additional request for access is made for the memory block, the ACC value may be incremented by one for each additional request and the block reassigned to a next higher buffer layer queue. As each request for access for the memory block is discontinued or closed, the ACC value may be decremented by one.

As long as the ACC value associated with a given block remains greater than or equal to one, it remains assigned to a given memory queue within buffer management structure layer 310, and is organized within the given buffer layer memory queue using the LRU organizational scheme previously described. When the ACC value associated with a given block decreases to zero (all requests or access cease), the memory block may be reassigned to a given memory queue within cache management structure layer 312, where it is organized following the LRU organizational scheme previously described. If a new request for access to the memory block is made, the value of ACC is incremented from zero to one and it is reassigned to a buffer layer memory queue. If no new request for access is made for the memory block it remains in a queue within cache layer 312 and is reassigned between and within the cache layer memory queues until it is removed from the queue in a manner as previously described.

Within FIG. 1, the variable K represents the total number of queues present in each layer and may be a configurable parameter, for example, based on the cache size, “turnover” rate (how quick the content will become “cold”), the request hit intensity, the content concentration level, etc. In the case of FIG. 1, K has the value of four, although any other total number of queues (K) may be present including fewer or greater numbers than four. In one exemplary embodiment, the value of K is less than or equal to 10.

The queues in buffer layer 310 are labeled as Q₁^{used}, Q₂^{used}, . . . Qₖ^{used}, and the queues in cache layer 312 are labeled as Q₁^{free}, Q₂^{free}, . . . Qₖ^{free}. The queues in buffer layer 310 and cache layer 312 are each shown organized in sequentially ascending order using sequentially ordered identification values expressed as subscripts 1, 2, 3, . . . K, and that are ordered in this example, sequentially from lowermost to highermost value, with lowermost values closest to memory unit removal as will be further described herein. It will be understood that a sequential identification value may be any value (e.g., number, range of numbers, integer, other identifier or index, etc.) that may be associated with a queue or other memory position that serves to define relative position of a queue within a layer and that may be correlated to one or more memory parameters, for example, in a manner so as to facilitate assignment of memory units based thereon. As previously described, each of the queues of FIG. 1 are shown as exemplary LRU organized queues, with the “most-recently-used” memory block on the top of the queue and the “least-recently-used” memory on the bottom.

As previously indicated with regard to FIG. 1, the entire memory space used by buffering and cache layers 310 and 312 of memory management structure 300 may be logically partitioned into three parts: buffer space, cache space, and free pool. In this regard, cache layer queue Q₁^{free} is the free pool to which is assigned blocks having the lowest caching priority. The remaining layer 312 queues (Qᵢ^{free}, i>1) may be characterized as the cache, and the layer 310 queues (Qᵢ^{used}) characterized as the buffer.

The provision of multiple queues within each of multiple layers 310 and 312 enables both “vertical” and “horizontal” assignment and reassignment of memory within structure 300. As previously described, “vertical” reassignment between the two layers 310 and 312 may be managed by an algorithm in combination with a parameter such as an ACC value that tracks whether or not there exists an active connection (i.e., request for access) to the block. Thus, when an open connection is closed, the ACC value of each of its associated blocks will decrement by one.

As previously described, a given memory block may have a current ACC value greater than one and be currently assigned to a particular memory queue in buffer layer 310, denoted here as Qᵢ^{used} where the queue identifier i represents the number of the queue within layer 310 (e.g., 1, 2, 3, . . . K). Upon decremation of its ACC value to zero, the block will be vertically reassigned to the top of a cache layer queue, vertically re-locating the block from buffer layer 310 to cache layer 312. The particular cache layer queue to which the block is reassigned may be dependent on the status of another parameter or combination of parameters, as will be discussed in further detail herein. However, if the ACC value of the same given block is greater than zero after decremation of the ACC value the block will not be reassigned from layer 310 to layer 312. Thus, the layer of the queue (i.e., buffer or cache) to which a given memory block is vertically assigned reflects whether or not an active request for access to the block currently exists, and the relative vertical assignment of the memory block in a given buffer or cache queue reflects the recency of the last request for access to the given block.

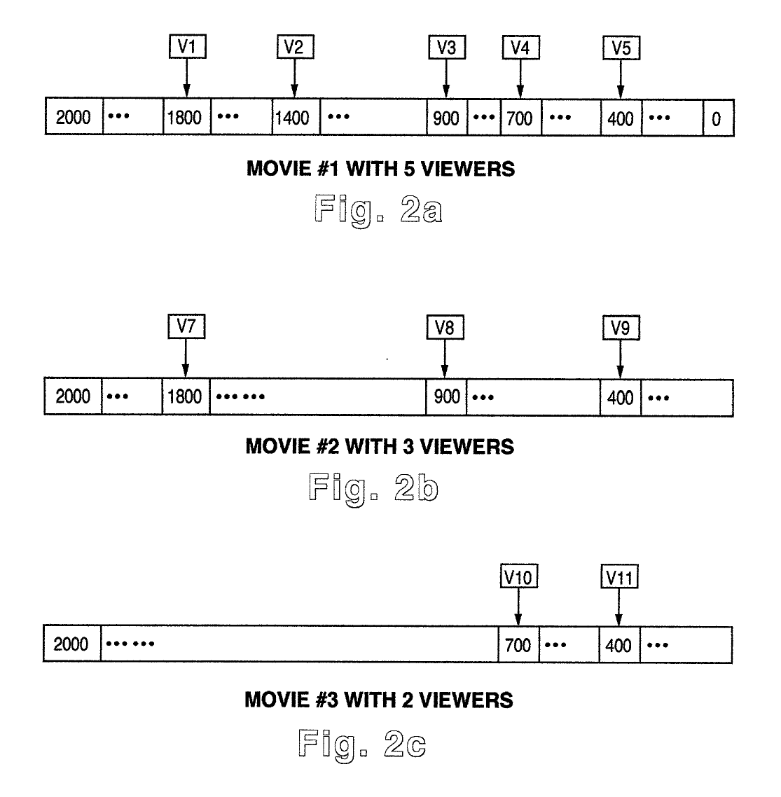

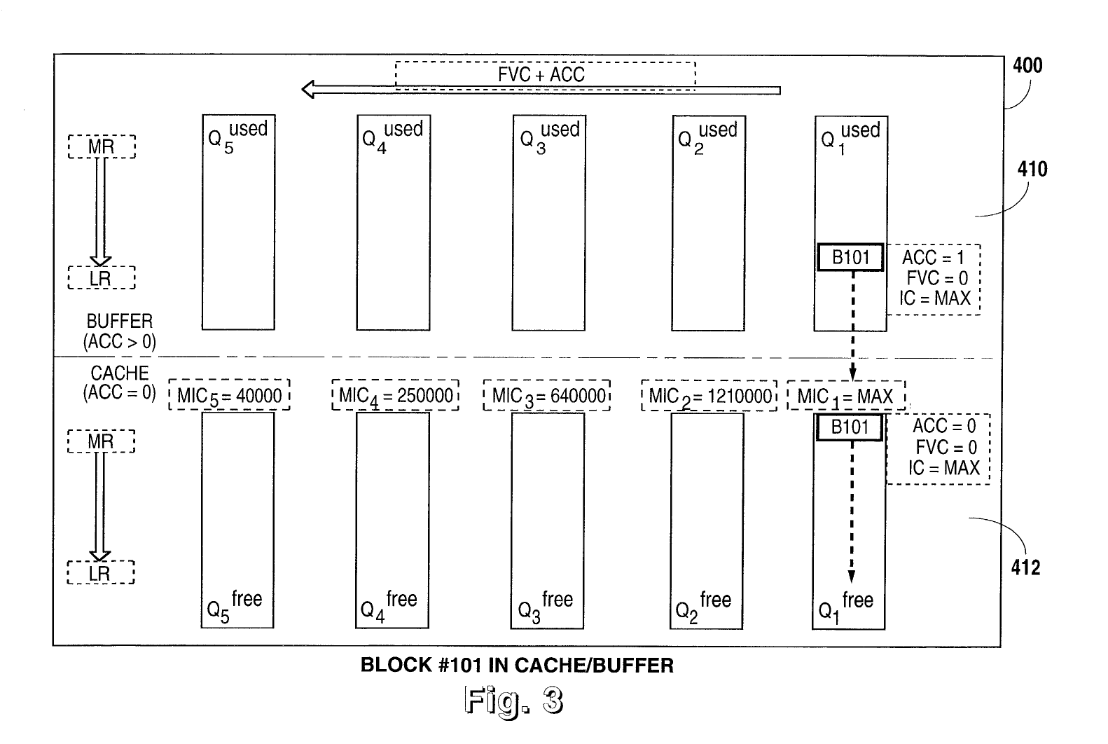

FIG. 2(a) through FIG. 11 are now provided to illustrate the implementation of embodiments of the disclosed methods and systems that not only utilize an integrated two dimensional memory management logical structure but that also advantageously employ: 1) a memory unit positioning rule that considers the trade-off between the value of a caching a given memory unit versus the cost of caching the memory unit; and 2) a memory unit replacement rule that avoids system stalls and hiccups to succeeding viewers by considering I/O admission control policy for succeeding viewers and by pro-actively removing memory units from cache memory assignment to ensure adequate buffer memory space. The illustrated embodiments are described in relation to continuous media data delivery environments, but it will be understood that one or more features of these embodiments may also be implemented in any other environment where over-size data objects are delivered or otherwise managed.

Referring now to FIGS. 2(a)-2(c), another type of parameter that may be associated with individual memory blocks in the disclosed cache/buffer logical management structures used in continuous media data delivery environments is one that reflects popularity of a given memory block. To illustrate this concept, three individual movies are represented as three respective series of data blocks in FIGS. 2(a), 2(b) and 2(c). As used herein, the term “movie” is used to describe a multimedia object (e.g., streaming video file, streaming audio file, etc.) that may be logically represented as a series of data blocks (e.g. B0, B1, B2, . . . Bn) and that may be accessed by continuous playback.

As illustrated in FIGS. 2(a), 2(b) and 2(c), each movie is viewed by multiple viewers beginning at various times, which are represented by arrows pointing vertically down. For purposes of this illustration, a “viewer” of a movie may be described as a sequence of read operations that act on the movie in the order of its data blocks, for example, as represented by a read head that orderly slides through the sequence of data blocks that represent the movie. Therefore, the term “viewer” is not necessarily equivalent to the term “client” as used in the application point of view. For example, each “viewer” may have multiple “clients” who may share the same movie, the same show time and the same consumption rate. It will also be understood that in other embodiments relating to the delivery or management of non-continuous over-size data objects (e.g., over-size FTP files) the term “viewer” may be used to refer to a sequence of read operations that act on the over-size non-continuous data file in the order of its data blocks, in a manner similar to that described in relation to continuous media data.

An interval is formed when two consecutive viewers are reading a movie, beginning at different times and reading different data blocks at a given instant. Referring to FIG. 2(a), an interval may be denoted as (V1, V2), where viewer V1 is the preceding viewer and the V2 is the succeeding viewer. An a given instant, the instantaneous representation of an interval can be denoted as (V1, B1, V2, Bm) where B1 and Bm are two blocks of the movie that are currently read by V1 and V2, respectively, at the current instant. The life span of an interval begins when two consecutive viewers occur and terminates when the state of either one of the two viewers changes. For example, the life of an interval terminates if one of the viewers terminates, pauses, fast-rewinds, or fast-forwards. The life span of an interval may also terminate when the relative position of the two viewers changes due to the difference of two viewers reading speeds or consumption rate. The life of an interval may also terminate if a third viewer occurs in between the two viewers, which splits the original interval into two new intervals.

One example parameter that may be employed conceptually to measure popularity of a given memory block in a movie, such as those illustrated in FIGS. 2(a), 2(b) and 2(c), is referred to herein as Succeeding Viewer Count (“FVC”). The value of FVC for any given data block is the number of succeeding viewers of the data block following the current viewer. For example, FIG. 2(a) illustrates a data block 1800 in movie #1 currently being accessed by current viewer V1 with four viewers V2 through V4 following behind. The value of FVC for data block 1800 of movie #1 is therefore equal to four. In a similar manner, data block 1800 in movie #2 of FIG. 2(b) has an FVC that is equal to two. The value of a block of cached data may be considered to be directly proportional to the number of viewers who will access the data, and to be inversely proportional to the size of the data and the time required to keep the data in cache. Therefore FVC may be considered as a partial measure of the value of a cached data block since it reflects the number of I/O operations that may be saved by caching the data block.

Referring again to FIG. 1, horizontal assignment and reassignment of a memory block within logical structure 300 may be accomplished in one embodiment using an algorithm that considers both FVC and ACC values for a given data block. For example, when a request for access to a particular data block of a given movie is received it is fetched into the buffer management layer 310 from external storage. In this embodiment, the initial position queue (Qᵢ^{used}) of the memory block in buffer management structure layer 310 may be determined based on the sum of the values of active connection count (ACC) and succeeding viewer count (FVC) for the memory block. For example, if the sum of ACC and FVC for the memory block is less than the queue index number (k) of the uppermost buffer layer queue (Qₖ^{used}), the memory block may be assigned to the top of buffer layer queue Qᵢ^{used}, where i is equal to ACC+FVC. If the sum of ACC and FVC for the memory block is greater than or equal to the queue index number (K) of the uppermost buffer layer queue (Q_{K}^{used}) the memory block may then be assigned to the top of the uppermost buffer layer queue Q_{K}^{used}. Using this positioning rule, the relative horizontal positioning of a data block in management structure 300 reflects the popularity of the data.

Horizontal assignment may also be affected by additional concurrent requests for access to a given memory block. For example, if additional concurrent requests for access to the given memory block are received, the ACC value is incremented again and the block is horizontally reassigned to the next higher buffer queue. As with increasing value of FVC, horizontal reassignment of the block continues with increasing ACC value until the block reaches the last queue, Q_{K}^{used} where the block will remain as long as its ACC value is greater than or equal to one. Thus, the buffer queue to which a given memory block is horizontally assigned also reflects the number of concurrent requests received for access to the given block.

Once assigned to a queue Q₁^{free} in cache layer 312, a memory block will remain assigned to the cache layer until it is the subject of another request for access. As long as no new request for access to the block is received, the block will be horizontally reassigned downwards among the cache layer queues as follows. Within each cache layer queue, memory blocks may be vertically managed employing an LRU organization scheme as previously described in relation to FIG. 1. With the exception of the free pool queue (Q₁^{fee}), each cache layer queue (Qᵢ^{free}, i>1) may be fixed in size so that each memory block that is added to the top of a non-free pool cache layer queue as the most recently used memory block serves to displace and cause reassignment of the least recently used memory block from the bottom of the non-free pool cache layer queue to the top of the next lower cache layer queue Q₁₋₁^{free}, for example, in a manner as indicated by the arrows in FIG. 1. This vertical reassignment will continue as long as no new request for access to the block is received, and until the block is reassigned to the last cache layer queue (Q₁^{free}), the free pool.

Thus, by fixing the depth of non-free pool cache layer queues Q_{K}^{free}. . . Q₃^{free} and Q₂^{free}, memory blocks having older reference records (i.e., last request for access) will be gradually moved down to the bottom of each non-free pool cache queue (Qᵢ^{free}, i>1) and be reassigned to the next lower cache queue Qᵢ₋₁^{free} if the current non-free pool cache queue is full. By horizontally reassigning a block in the bottom of each non-free pool cache queue (Qᵢ^{free}, i>1) to the top of the next lower cache queue Qᵢ₋₁^{free}, reference records that are older than the latest reference (i−1) may be effectively aged out. However, if a memory block within Qᵢ^{free} is referenced (i.e., is the subject of a new request for access) prior to being aged out, then it will be reassigned to a buffer layer queue Qᵢ^{used} in a manner as dictated by its ACC and FVC values as described elsewhere herein. This reassignment ensures that a block in active use is kept in the buffer layer 310 of logical structure 300.

It is possible that the buffer layer queues and/or the last cache layer queue Q₁^{free} may be fixed in size like non-free pool cache layer queues (Qᵢ^{free}, i>1). However, it may be advantageous to provision all buffer layer queues Qᵢ^{used}. . . Q₃^{used}, Q₂^{used} and Q₁^{used} to have a flexible size, and to provision last cache layer queue Q₁^{free} as a flexible-sized memory free pool. In doing so, the amount of memory available to the buffer layer queues may be maximized and memory blocks in the buffer layer will never be removed from memory. This is so because each of the buffer layer queues may expand as needed at the expense of memory assigned to the free pool Q₁^{free}, and the only possibility for a memory block in Q₁^{used} to be removed is when all active connections are closed. In other words, the size of memory free pool Q₁^{free} may be expressed at any given time as the total available memory less the fixed amount of memory occupied by blocks assigned to the cache layer queues less the flexible amount of memory occupied by blocks assigned to the buffer layer queues, i.e., free pool memory queue Q₁^{free} will use up all remaining memory space.

In one possible implementation, an optional queue head depth may be used in managing the memory allocation for the flexible sized queues of a memory structure. In this regard, a queue head depth counter may be used to track the availability of the slots in the particular flexible queue. When a new block is to be assigned to the queue, the queue head depth counter is checked to determine whether or not a new block assignment may be simply inserted into the queue, or whether a new block assignment or group of block assignments are first required to be made available. Other flexible queue depth management schemes may also be employed.

In the embodiment of FIG. 1 when a new memory block is required from storage (e.g., a miss), an existing older memory block assignment is directly removed from the bottom of free pool queue Q₁^{free} and replaced with an assignment of the new requested block to buffer layer queue Q₁^{used}.

As is the case with other embodiments described herein, storage and logical manipulation of memory assignments described in relation to FIG. 1 may be accomplished by any processor or group of processors suitable for performing these tasks. Examples include a buffer/cache manager (e.g., storage management processing engine or module) of an information management system, such as a content delivery system. Likewise resource management functions may be accomplished by a system management engine or host processor module of such as system. Likewise resource management functions may be accomplished by a system management engine or host processor module of such a system. A specific example of such a system is a network processing system that is operable to process information communicated via a network environment, and that may include a network processor operable to process network-communicated information and a memory management system operable to reference the information based upon a connection status associated with the content.

Examples of a few of the types of system configurations with which the disclosed methods and systems may be advantageously employed are described in concurrently filed, copending United States patent application serial number ______, entitled “Network Connected Computing System”, by Scott C. Johnson et al.; and in concurrently filed, co-pending United States patent application serial number ______, entitled “System and Method for the Deterministic Delivery of Data and Services,” by Scott C. Johnson et al., each of which is incorporated herein by reference. Other examples of memory management methods and systems that may be employed in combination with the method and systems described herein may be found in concurrently filed, co-pending United States patent application serial number ______, entitled “Systems and Methods for Management of Memory”, by Chaoxin C. Qiu, et al., which is incorporated herein by reference.

Optional additional parameters may be considered by a caching algorithm to minimize unnecessary processing time that may be consumed when a large number of simultaneous requests are received for a particular memory unit (e.g., particular file or other unit of content). Examples of such parameters include, but are not limited to, a specified resistance barrier timer (“RBT”) parameter that may be compared to a sitting time (“ST”) parameter of a memory block within a given queue location to minimize unnecessary assignments and reassignments within the memory management logical structure. Consideration of such a parameter is described in concurrently filed, co-pending United States patent application serial number ______, entitled “Systems and Methods for Management of Memory,” Chaoxin C. Qiu et al., which is incorporated herein by reference.

Although it is possible to employ an algorithm that considers an optional barrier parameter as described above for the management of memory in continuous media data delivery environments (e.g., streaming video, streaming audio), just as it may be employed in non-continuous information delivery environments (e.g., HTTP/FTP). However, in many continuous media data delivery embodiments it may not be necessary or desirable to employ an algorithm that considers a barrier parameter such as RBT. This is because it may be desirable that multiple requests for access to the same group of memory units (e.g., multiple requests for the same movie from multiple clients) that arrive in short time differences be batched whenever possible in order to improve system efficiency.

One or more configurable parameters of the disclosed memory management structures may be employed to optimize and/or prioritize the management of memory. Examples of such configurable aspects include, but are not limited to, cache size, number of queues in each layer (e.g., based on cache size and/or file set size), processor-assigned flags associated with a memory block, etc. Such parameters may be configurable dynamically by one or more system processors (e.g., automatically or in a deterministic manner), may be pre-configured or otherwise defined using by a system manager such as a system management processing engine, or configured using any other suitable method for real-time configuration or pre-configuration.

For example, one or more optional flags may be associated with one or more memory blocks in the cache/buffering memory to influence the behavior of the memory management algorithm with respect to given blocks. These flags may be turned on if certain properties of a file are satisfied. For example, a file processor may decide whether or not a flag should be turned on before a set of blocks are reserved for a particular file from external storage. In this way one or more general policies of the memory management algorithm described above may be overwritten with other selected policies if a given flag is turned on.

In the practice of the disclosed methods and systems, any type of flag desirable to affect policies of a memory management system may also be employed. One example of such a flag is a NO_CACHE flag, and it may be implemented in the following manner. If a memory block assigned to the buffer layer 310 has its associated NO_CACHE flag turned on, then the block will be reassigned to the top of the free pool Q₁^{free} when all of its associated connections or requests for access are closed (i.e. when its ACC value equals zero). Thus, when so implemented, blocks having a NO_CACHE flag turned on are not retained in the cache queues of layer 312 (i.e., Q₂^{free}, Q₃^{free}, and Qₖ^{free}).

In one exemplary embodiment, a cache eligibility flag may be employed that takes one of two possible values: “CACHE_OK” and “NO_CACHE” state. When a continuous media data delivery interval is created, the flag may be set to “CACHE_OK”. When the data block of the interval is replaced or removed from buffer/cache memory, the flag may be set to “NO CACHE”. After the flag is changed to “NO_CACHE”, it will not be changed until the end of the interval's life span. When an interval is set to “NO_CACHE”, the data blocks read by the preceding viewer will not be cached. It means that after they are consumed by the preceding viewer, the data blocks will be directly inserted into the bottom of the free pool (Q₁^{free}) and will be eligible for replacement. It will be understood that other types of flags, and combinations of multiple flags are also possible, including flags that may be used to associate a priority class with a given memory unit (e.g., based on Quality of Service (“QoS”) parameters, Service Level Agreement (“SLA”) parameter), etc. For example, such a flag may be used to “push” the assignment of a given memory to a higher priority queue, higher priority memory layer, vice-versa, etc.

Yet another type of parameter that may be associated with individual memory blocks in the practice of the disclosed cache/buffer logical management structures is a parameter that reflects the cost associated with maintaining a given memory block in buffer/cache memory in a continuous media data environment. Examples of such parameters include, but are not limited to, Interval Size representing the physical size of the interval between a preceding viewer and a succeeding viewer of the same memory block (e.g., as measured in bytes), Consumption Rate of a particular viewer (e.g., as measure in bytes/second), time period that a given block waits in memory before it is reused by a succeeding viewer, etc. and combinations thereof. Thus, unlike conventional caching methods for streaming media data that only consider interval size, the disclosed methods and systems advantageously allow other types of parameters such as consumption rate to be considered, as well as combinations of parameters such as interval size and consumption rate, so as to provide a much better measure of actual cost associated with caching a given memory unit.

One example of a cost parameter that reflects a combination of a number of individual cost parameters is referred to herein as interval cost (“IC”), and reflects the time period a block has to wait before it is reused by a succeeding viewer as well as its physical size. In one embodiment, the interval cost of a given block may be calculated as follows:

IC=IntervalSize*(IntervalSize/ConsumptionRate) (1)

where: IntervalSize=interval between the preceding viewer and the next succeeding viewer; and ConsumptionRate=consumption rate of the next succeeding viewer.

To illustrate the above equation, if the interval size is measured in number of bytes between the preceding viewer and the next succeeding viewer, and the consumption rate of the next succeeding viewer is measured in bytes/second, then IC is calculated in units of Byte-Seconds. It should be pointed out that even though the actual consumption rate may be a run-time dynamic parameter, it is possible to get an estimation of average consumption rate based on known information such as client bandwidth, playback rate, etc.

When implemented in the disclosed memory management structures, there are several ways to mitigate the processing cost that may be incurred in the calculation of IC that may result from the division and multiplication involved per block as defined in equation (1). For example, the calculation may be performed for a group of blocks, rather than block by block. In a readahead implementation, this may be done by performing the IC calculation on the entire readahead segment. Alternatively, for deployment environments where the consumption rates do not vary dramatically it may be unnecessary to factor in consumption rate. For example, if the consumption rate is fairly consistent the IC calculation may be relaxed by directly using the measurement of number of blocks (or bytes), so that IC may be defined as the physical size of an interval.

As an alternative to IC equation (1), a simplified IC equation (1′) may be employed:

IC=IntervalSize/Sqrt(ConsumptionRate). (1′)

Because there is generally only a finite number of defined consumption rates, most of the calculations in (1′) may typically be realized by using one division if, for example, the square root value of the defined consumption rates are pre-stored. However, in an implementation where the actual consumption rates are measured and used, the total cost of calculating (1′) may be higher if the actual consumption rates vary frequently from the defined rates. Thus, although particular exemplary embodiments for calculation of IC have been disclosed herein, it will be understood with benefit of this disclosure that in the practice of the disclosed buffer/cache memory management structures one or more parameters reflecting the cost associated with maintaining a given memory block in buffer/cache memory may be combined and factored together in a variety of ways as so desired to fit particular characteristics and/or needs of a given continuous media data delivery embodiment.

Parameter/s that reflect the cost associated with maintaining a given memory block in buffer/cache memory may be implemented in a number of ways to more effectively manage memory in a buffer/cache memory management structure. For example, referring to FIG. 1, when the ACC value associated with a given block decreases from a positive integer value to zero (i.e., all requests or access cease), the memory block may be reassigned from a queue in buffer layer 310 to a queue in cache layer 312. Although it is possible to implement a management structure in which such a memory block is automatically reassigned form a buffer layer queue Qᵢ^{used} to a corresponding cache layer queue Qᵢ^{free} in cache layer (i.e., having the same index number), this may not be desirable for memory blocks associated with a high IC. To address this concern, values of IC associated with each memory block may be considered in the block reassignment decision.

For example, in one exemplary embodiment, a “cache-scaling” value of Maximum Interval Cost (“MIC”) may be assigned to each queue of cache layer 312 and expressed as MICᵢ, where i represents the index number of the given cache layer queue, Qᵢ^{free}. Cache-scaling values such as MIC may be used to affect the cache layer queue assignment of a given block, for example, based on the cost of the interval associated with the block. Values of MICᵢ may be implemented so as to be configurable, for example, based on the workload pattern as seen by the server, and may be expressed in units consistent with those employed for IC (e.g., byte-seconds), so as to allow the respective values of MIC and IC to be compared as will be described further herein.

Cache-scaling values such as MIC may be assigned as so desired, e.g., to implement a desired policy or policies for managing memory within the disclosed buffer/cache memory management logical structures. For example, values of MIC may be assigned and implemented in a manner so as to “scale” the cache layer queue assignment of a given data block such that a data block that is associated with relatively higher IC value (e.g., that must wait longer before being reused relative to other blocks) is positioned in a cache layer queue Qᵢ^{free} having an index i that is lower than its associated popularity parameters (e.g., ACC, FVC, etc.) would have otherwise positioned it. By so considering the IC value in the reassignment algorithm, it is possible to position cached blocks in the management structure according to their resource cost.

For example, in one exemplary embodiment, each Qᵢ^{free} may have an assigned value of MICi that satisfies the following rule: MICᵢ₊₁<MICᵢ. Therefore, for a cache layer having a lowermost cache layer queue represented by the index value 1 and an uppermost cache layer queue represented by index value k, MIC values may be assigned to the queues so as to have an inter-queue relationship as follows: MICₖ<MICₖ₋₁< . . . <MICᵢ<MICᵢ₋₁< . . . <MIC₂<MIC₁). In such an embodiment, value of MIC₁ may be set to “MAX” (i.e., infinite) for the free pool queue Q₁^{free}. In the given embodiment, when the ACC value of a data block drops to zero, the data block may be reassigned from a given buffer layer queue to one of the cache queues according to the following rule. A given data block in a buffer layer queue Qᵢ^{used} will be vertically reassigned to the corresponding cache layer queue Qᵢ^{free} if the MIC value of the corresponding cache layer queue Qᵢ^{free} is greater than or equal to the IC value of the data block. However, if the MIC value associated with the corresponding cache layer queue Qᵢ^{free} is less than the IC value of the data block, then the data block will be reassigned to next lower cache layer queue having a MIC that is greater than or equal to the IC value of the data block.

Using the above-described embodiment, data blocks are reassigned from buffer layer 310 to cache layer 312 in a manner such that the IC values of the individual data blocks assigned to a given cache layer queue Qᵢ^{free} have the following relationship to the MIC value of the assigned cache layer queue Qᵢ^{free} and the MIC value of the next higher cache layer queue Qᵢ₊₁^{free}: MICᵢ₊₁<IC<MICᵢ. If the IC value of a given data block is “MAX” (i.e., no interval), then the data block is inserted into the bottom of the free pool, Q₁^{free}. Although values of IC and MIC have been described herein in units of byte-seconds, it will be understood that other units may be employed. For example, in embodiments employing a fixed block size, units of block-seconds may be calculated using the block size.

Although two layers of memory queues are illustrated for the exemplary embodiments of FIGS. 1 and 2, it will be understood that more than two layers may be employed, if so desired. For example, two buffer layers e.g., a primary buffer layer and a secondary buffer layer, may be combined with a single cache layer or a single buffer layer may be combined with two cache layers, e.g., a primary cache layer and a secondary cache layer, with reassignment between the given number of layers made possible in a manner similar to reassignment between layers 310 and 312, of FIG. 1, and between layers 310 and 312 of FIG. 1. For example, primary and secondary cache and/or buffer layers may be provided to allow prioritization of particular memory units within the buffer or cache memory.

FIGS. 3-7 illustrate one example of how data blocks of the movies of FIGS. 2(a), 2(b) and 2(c) may be assigned and reassigned according to the above-described embodiment of a cache/buffer management structure 400 employing the parameters ACC, FVC, IC and MIC. In the illustrated embodiment, each of buffer layer 410 and cache layer 412 include five LRU queues (i.e., k=5), each of which is internally organized with most recently used (“MR”) blocks at the top of the queue and least recently used (“LR”) blocks at the bottom of the queue. MIC values are shown assigned to each of the five queues in cache layer 412, and increase in value with descending cache queue index in a manner as previously described. For the sake of simplicity, this example assumes that the consumption rate of all viewers is constant at 1 block per second, and all IC values are expressed in the unit of block-seconds.

FIG. 3 illustrates treatment of a data block 101 of each of movies #1, #2, and #3 of respective FIGS. 2(a), 2(b) and 2(c). As may be seen in these figures, the smallest interval size between any two viewers of these three movies is the 200 block interval between viewers V3 and V4 of movie #1 of FIG. 2(a), almost twice as large as the interval between block 101 and the starting block of the movie (i.e., block 1). Thus, at the time a block 101 of any of the three movies is currently being viewed by any of the viewers shown, there will be no known succeeding viewer for the block. This is due to the fact that the smallest interval between a current viewer and a succeeding viewer for the block is 200 blocks behind block 101 (i.e., block 101 will already have been viewed by the first viewer before the next viewer for the block is known).

At the time of viewing by each respective viewer, a block 101 of any of the illustrated movies has an ACC of 1, an FVC of 0 and an IC of MAX (infinite), and is inserted into the top hof buffer layer Q₁^{used} at time of viewing (i.e., ACC+FVC=1). A block 101 of any of the movies is then vertically reassigned to the top of Q₁^{free} after it is consumed by the viewer and the ACC drops to 0, as indicated by the arrow in FIG. 3. This behavior is the same with regard to block 101 for all viewers depicted in FIGS. 2(a), 2(b) and 2(c). In the illustrated embodiment, blocks like this will be the top candidates for replacement by virtue of downward LRU movement in Q₁^{free} as also shown by the downward arrow in FIG. 3.

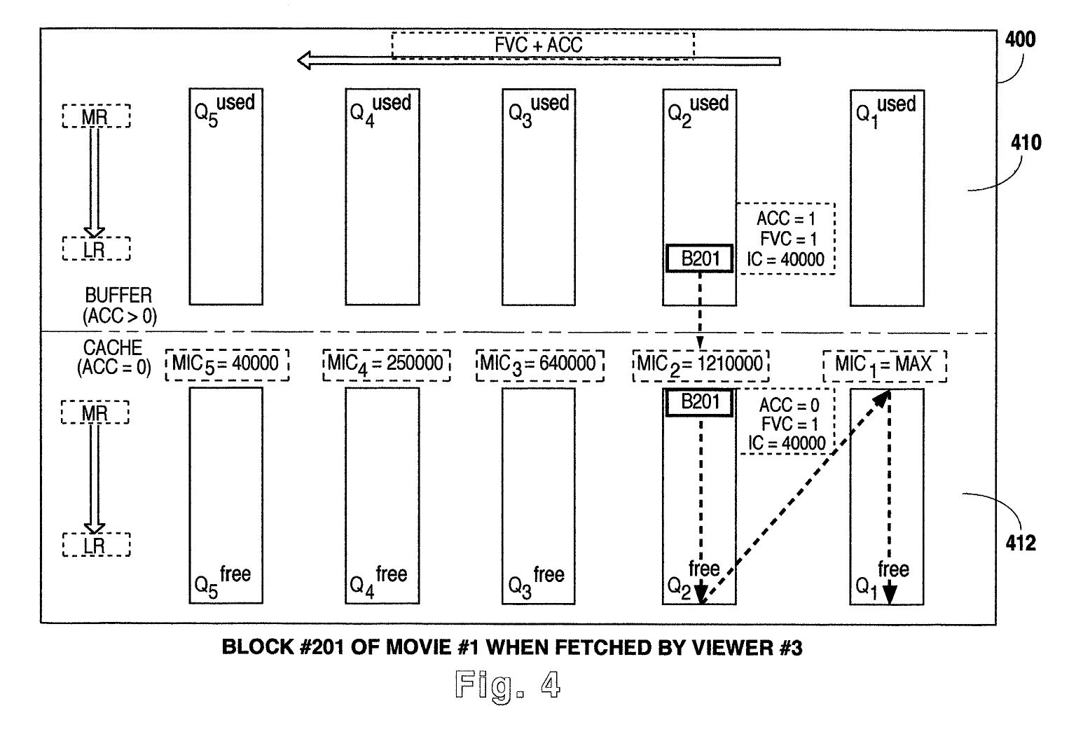

FIG. 4 illustrates treatment of a data block 201 of movie #1 of FIG. 2(a). The interval between data block 201 and the starting block of the movie is now equal to the 200 block interval size between viewers V3 and V4 of FIG. 2(a). Thus, at the time viewer #3 fetches block 201 in movie #1, viewer V4 has already occurred and is known to the system. This means when viewer V3 fetches the block, the FVC value for block 201 is equal to 1, the ACC value is equal to 1, and the IC between viewers V3 and V4 is equal to 40,000 block-seconds (i.e., 200 blocks*(200 blocks/1 block per second)). Therefore, block 201 is assigned to the top of buffer layer Q₂^{used} at time of viewing by viewer V3 (i.e., ACC+FVC=2).

FIG. 4 shows that the block 201 will be vertically reassigned to the top of Q₂^{free} after it is consumed by viewer V3 and the ACC drops to 0, as indicated by the arrow in FIG. 4. This is reassignment to the corresponding cache layer queue is allowed by the system because the IC value of block 201 is 40,000 block-seconds, which is less than the MIC₂ of 121,000 block-seconds associated with Q₂^{free}. As shown by the arrows in FIG. 4, due to the LRU organization of the queues, block 201 then continuously moves down Q₂^{free} and is then reassigned to Q₁^{free} where it moves down until being replaced, unless beforehand it becomes subject of a subsequent request for access (e.g., by the succeeding viewer represented by the FVC value of one), in which case block 201 will be reassigned to Q₁^{used} (ACC+FVC=1), where it will remain until consumed by the succeeding user and is reassigned to Q₁^{free}. When fetched by viewers V1, V2, V4 and V5 of movie #1, queue assignment and reassigmnent of block 201 is similar to block 101 in FIG. 3, since the value of FVC is 0 in each of these cases.

Although not illustrated, when block 301 of movie #1 of FIG. 2(a) is fetched by viewers V1, V2, and V5 of movie #1, queue assignment and reassignment of block 201 is similar to block 101 in FIG. 3, as the value of FVC is 0 in each of these cases. When the same block 301 is fetched by the viewers V3 and V4, its positioning is similar to block 201 in FIG. 4, since the value of FVC is equal to 1 in each of these cases. Furthermore, it will be understood that in each of the embodiments illustrated herein, a given block is reassigned to the appropriate buffer layer queue when a succeeding viewer re-uses the block. Thus, as for block 201 of FIG. 4, if and when a succeeding viewer requests access to a given block that is assigned to a cache layer queue, the ACC value will increment to a value of one and the block reassigned to Q₁^{used}.

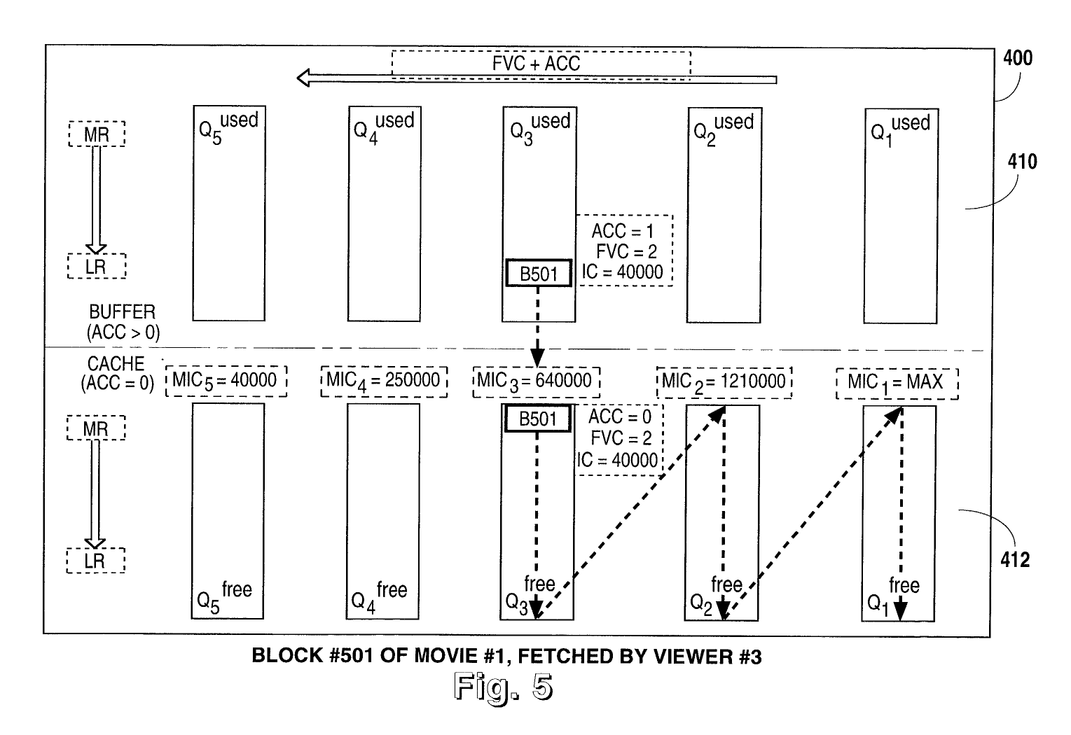

FIG. 5 depicts assignment and reassignment of block 501 of movie #1 of FIG. 2(a) when it is fetched by viewer V3. When viewer V3 fetches block 501, there are two known succeeding viewers, V4 and V5, which follow behind by intervals of 200 blocks and 500 blocks respectively. Therefore, when fetched by viewer V3, block 501 has an FVC value of 2, an ACC count of 1, and an IC of 40,000 block-seconds (i.e., 200 blocks*(200 blocks/1 block per second)). V3 is therefore assigned to Q₃^{used} (i.e., FVC+ACC=3). Upon consumption by viewer V3, the ACC value falls to 0, and block 501 is reassigned vertically downward to corresponding cache layer queue Q₃^{free} which has an MIC₃ of 640,000 block-seconds, much greater than the IC value of block 501. As shown by the arrows in FIG. 5, due to the LRU organization of the queues, block 501 then continuously moves down Q₃^{free}, is reassigned to the top of Q₂^{free} where it moves downward and is then reassigned to Q₁^{free} where it moves down until being replaced.

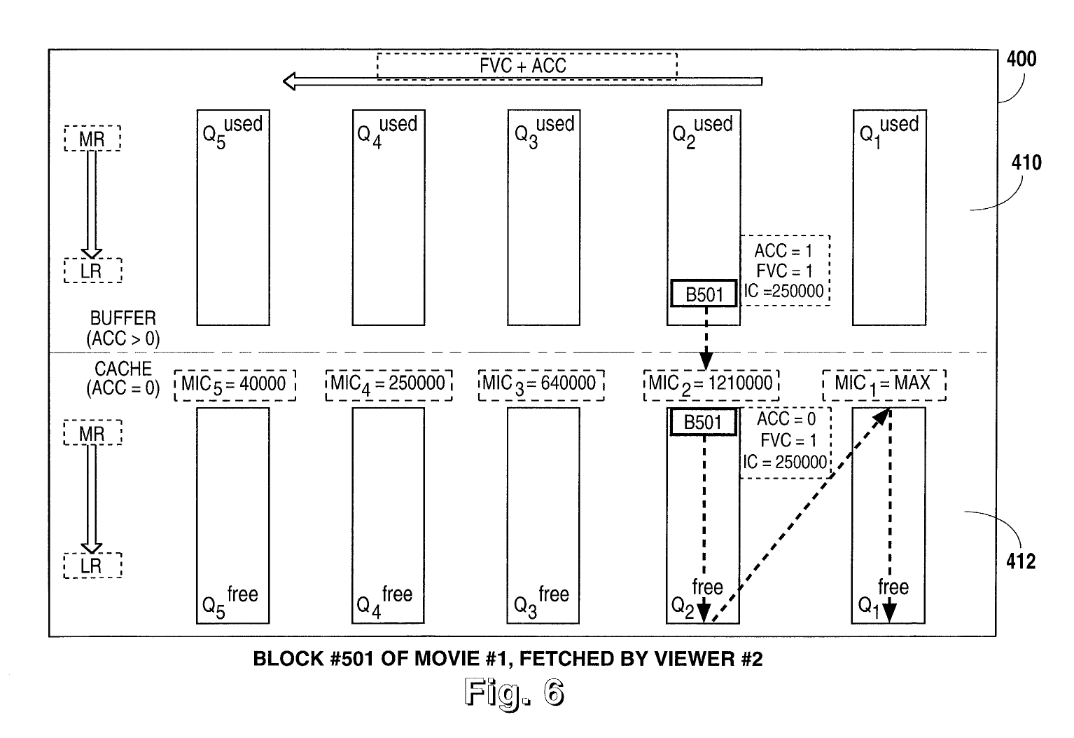

FIG. 6 depicts assignment and reassignment of block 501 of movie #1 of FIG. 2(a) when it is fetched by viewer V2. When viewer V2 fetches block 501, there is one known succeeding viewers, V3, which follows behind by an interval of 500 blocks. When fetched by viewer V2, block 501 has an FVC value of 1, an ACC count of 1, and an IC of 250,000 (i.e., 500 blocks*(500 blocks/1 block per second)). Block 501 is therefore assigned to Q₂^{used} (i.e., FVC+ACC=2). Upon consumption by viewer V2, the ACC value falls to 0, and block 501 is reassigned vertically downward to corresponding cache layer queue Q₂^{free} which has an MIC₃ of 1,210,000 block-seconds, much greater than the IC value of block 501. Reassignment and replacement of block 501 through the remaining cache layer queues then occurs in a manner as previously described.

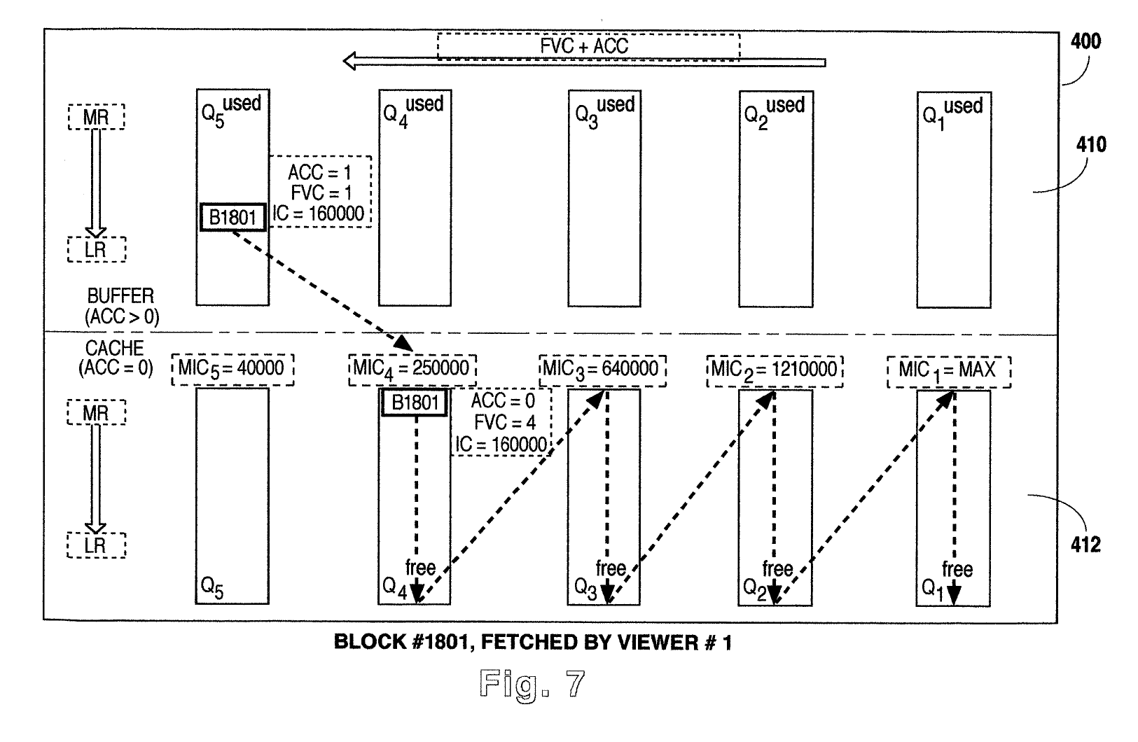

In the above-described examples related to FIGS. 3-6, the interval cost (IC) values associated with the data blocks did not impact the data block vertical reassignment to the corresponding cache layer queues. FIG. 7 is given to illustrate an example where the IC value does impact reassignment.

FIG. 7 depicts assignment and reassignment of block 1801 of movie #1 of FIG. 2(a) when it is fetched by viewer V1. When viewer V1 fetches block 1801, there are four known succeeding viewers, V2, V3, V4 and V5, which follow behind by intervals of 400 blocks, 900 blocks, 1100 blocks and 1400 blocks respectively. Therefore, when fetched by viewer V1, block 1801 has an FVC value of 4, an ACC count of 1, and an IC of 160,000 block-seconds (i.e., 400 blocks*(400 blocks/1 block per second)). Block 1801 is therefore assigned to Q₅^{used} (i.e., FVC+ACC=5).

Upon consumption of block 1801 by viewer V1, its ACC value falls to 0, and block 1801 is reassigned vertically downward to cache layer 412. However, block 1801 is not assigned by the system to the corresponding cache layer queue Q₅^{free} because MIC₅ is equal to 40,000 block-seconds, less than the 160,000 block-seconds IC value associated with block 1801. Instead, block 1801 is also reassigned horizontally to the uppermost cache layer queue having an associated MIC value that is greater than or equal to the IC value of the current block, 1801. In this case, block 1801 is reassigned to cache layer queue Q₄^{free} having an MIC₄ of 250,000 block-seconds which is greater than the 160,000 block-seconds IC value associated with block 1801. For illustration purposes, had block 1801 had an associated IC value of 275,000, it would have been reassigned to cache layer queue Q₃^{free} having an MIC₄ of 640,000 block-seconds, which is greater than the 275,000 block-seconds IC value. Reassignment and replacement of block 1801 through the remaining cache layer queues then occurs in a manner as previously described.

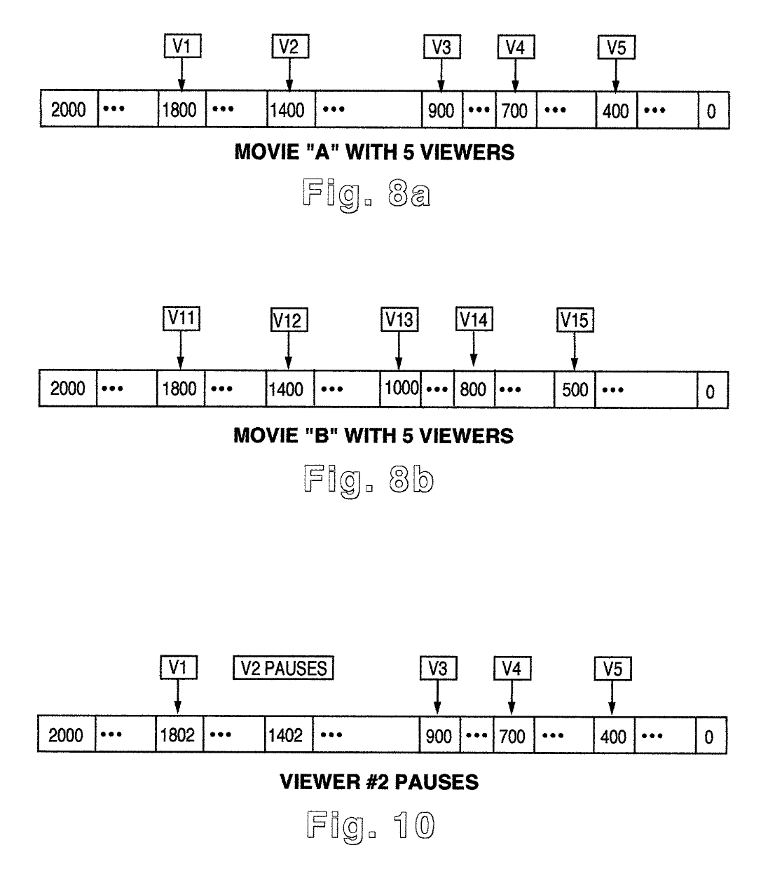

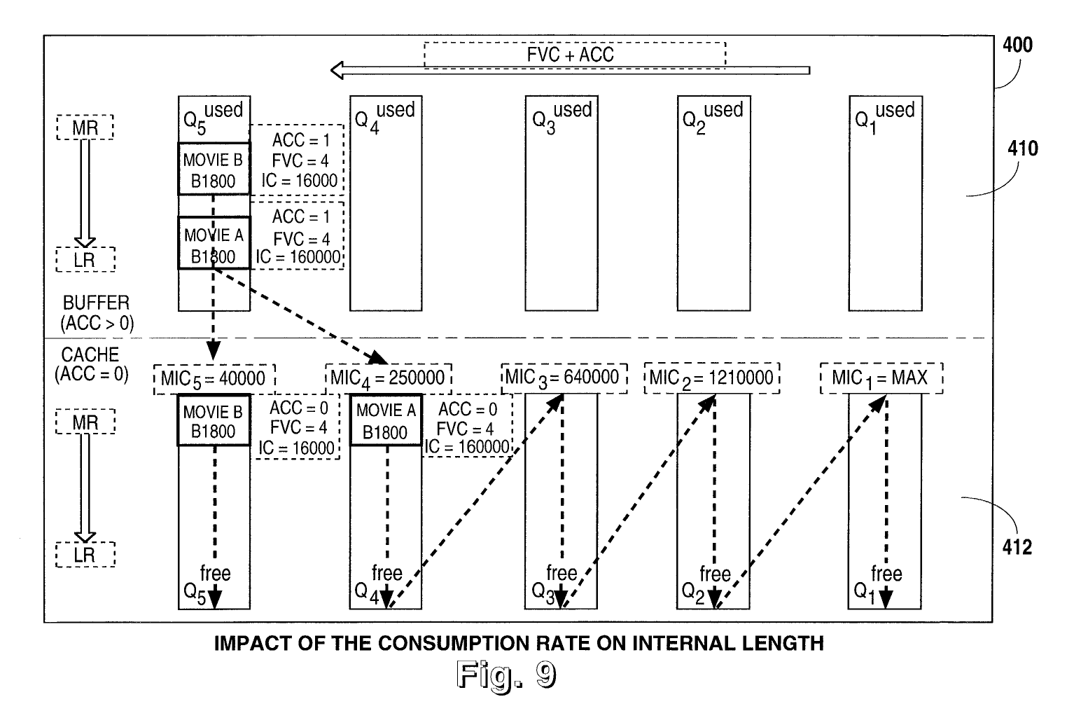

FIG. 9 illustrates treatment assignment and reassignment of data blocks that may occur using the memory management structure 400 of FIGS. 3-7, when viewers having different consumption rates are encountered, in this case for two different movies A and B illustrated in respective FIGS. 8(a) and 8(b).

Referring now to FIGS. 8(a) and 8(b), viewer V2 of movie A of FIG. 8(a) has a consumption rate of 1 block per second, and viewer V12 of movie B of FIG. 8(b) has a consumption rate of 10 blocks per second. This difference in consumption rates means that even though the interval between viewers V1 and V2 and the interval between viewers V11 and V12 have the same physical size of 400 blocks, it will take viewer V2 400 seconds to consume the blocks between block 1400 and block 1800 of movie A, but it will only take viewer V12 40 seconds to reach block 1800 of movie B. In other words, the interval cost of block 1800 of movie A is much higher than the interval cost of block 1800 of movie B. Therefore, using the memory management structure 400 of FIG. 9, block 1800 of movie A is treated much differently than block 1800 of movie A.

As illustrated in FIG. 9, when viewed by respective viewers V1 and V11, each of block 1800 of movie A and block 1800 of movie B have four known succeeding viewers as shown. When fetched by viewer V1, block 1800 of movie A has an FVC value of 4, an ACC count of 1, and an IC of 160,000 block-seconds (i.e., 400 blocks*(400 blocks/1 block per second)). Block 1800 of movie A is therefore assigned to Q₅^{used} (i.e., FVC+ACC=5). Similarly, when fetched by viewer V11, block 1800 of movie B has an FVC value of 4 and an ACC count of 1, and is therefore also assigned to Q₅^{used} (i.e., FVC+ACC=5). However, because of the 10 block per second consumption rate of viewer V12, block 1800 of movie B has an IC of 16,000 block-seconds (i.e., 400 blocks*(400 blocks/10 blocks per second)).

After viewers V1 and V11 have consumed respective blocks 1800 of movie A and movie B, the ACC values of these blocks drop to 0, and they are each reassigned vertically to cache layer 412. Block 1800 of movie B has an associated IC value of 16,000 block-seconds, which is less than the MIC₅ value of 40,000 block-seconds associated with Q₅^{free}. Block 1800 of movie B is therefore vertically reassigned downward from Q₅^{used} to corresponding cache layer queue Q₅^{free} as shown by the solid arrow in FIG. 9.

However, block 1800 of movie A has an associated IC value of 160,000 block-seconds, which is greater than the MIC₅ value of 40,000 block-seconds associated with Q₅^{free} Therefore block 1800 of movie A is reassigned both vertically downward and horizontally over to the uppermost cache layer queue having an associated MIC value that is greater than or equal to the 160,000 block-seconds IC value of block 1800, as indicated by the dashed arrows in FIG. 9. In this case, block 1800 is reassigned to Q₄^{free} having an MIC₄ of 250,000 block-seconds which is greater than the 160,000 block-seconds IC value associated with block 1800. Reassignment and replacement of each respective block 1800 of movie A and B through the remaining cache layer queues then occurs in a manner as previously described and shown by the arrows in FIG. 9.

It will be understood that the particular configuration of two dimensional integrated memory management structure 400 illustrated in FIGS. 3-7 and 9 is exemplary only and that the type, value and/or number of the various parameters illustrated therein may be varied as desired to fit the needs or characteristics of particular continuous media data delivery environments. For example, the algorithm of memory management structure 400 operates in a manner that tends to favor a later portion of a few hot movies (e.g., as seen by comparing FIG. 4 and FIG. 7). This may be desirable, for example, when economy of the limited cache memory favors caching the last portions of a few of the hottest movies in order to save the most I/O operations. However, the number of memory management layers, number of queues per layer (K), value of MIC associated with each cache layer queue, weighting factor assigned to interval cost (IC), active connection value (ACC) and succeeding viewer value (FVC), inter-queue organizational scheme, etc. may be varied to change the performance of the system. Furthermore, other factors derived from or otherwise representing or proportional to the parameters of recency, frequency, popularity, interval size, interval time, viewer consumption rate, cache resource cost, etc. may be substituted or employed in conjunction with the disclosed two dimensional integrated buffer/cache memory management structures to achieve desired memory management performance.

As previously described, use of an LRU inter-queue organizational scheme with fixed cache layer queue sizes Qᵢ^{free} (i>1) may be employed to cause downward movement of a given memory block assignment until it reaches the bottom of a given cache layer queue and is reassigned to the next lower cache layer queue Qᵢ₋₁^{free}. By so reassigning a block in the bottom of LRU queue Qᵢ^{free} (i>1) to the top of LRU queue Qᵢ₋₁^{free}, it is possible to effectively age out the weight accorded the FVC value associated with the given block by one. This provides beneficial effects to memory management when handling unpredictable user behaviors, such as may occur with VCR control operations and changing network situations, such as network congestion.

Cache replacement policy may impact the continuous delivery of media data in various ways. For example, when a data block of a given cached interval is replaced, it may cause a succeeding viewer of the given interval to read data from a disk. This transition results in a sudden increment of storage I/O capacity in both buffer space and I/O bandwidth. If a sufficient I/O capacity is not available, the succeeding viewer will not be able to get data on time to maintain continuous playback, and an interruption or “hiccup” in media data delivery may occur.

Referring again to FIGS. 2(a), 2(b) and 2(c) to illustrate this problem, assume that block 901 through block 1799 of movie #2 of FIG. 2(b) are currently assigned to the free pool Q₁^{free} and a part of this interval has been pushed down by the LRU organizational scheme to the bottom of the free pool Q₁^{free}, and viewer V8 is able to serve its clients by fetching data from the cache memory. However, assume a new viewer V11 of movie #3 shows up and requires buffer space for movie #3 data blocks. If the system allocates buffer space for blocks of movie #3 to serve viewer #11 by taking blocks that currently hold data for block #901 through block #1799 of movie #2, then the external storage I/O will require capacity that can support two additional viewers: viewer V8 and viewer V11. Therefore, if the system assigns buffer space for the blocks consumed by viewer V11 without knowing the impact to viewer V8, the I/O capacity may not be sufficient to support both viewers V8 and V11, resulting in an interruption (e.g., hiccup or stall) in media data delivery to viewer V8.

In one embodiment, the disclosed two dimensional integrated memory management structures may be implemented to control assignment of new data blocks to buffer memory so as to avoid interruptions to existing viewers. In one possible implementation of this embodiment, existing viewers whose intervals are to be replaced may be subject to external storage I/O admission control, or treated like new viewers. For example, an I/O admission control policy may be defined for a storage processor of an information management system, and may be configured to be aware of the available buffer space and the external storage I/O capacity. Whenever a viewer (new or existing) needs to be served by the data from external storage, it ensures that enough buffer and IOPS are available for the viewer. An admission policy algorithm also may be configured to calculate an optimal estimated read-ahead segment size that achieves a balance of buffer space and the IOPS. For each viewer, read-ahead length (i.e., the I/O buffer size) may be calculated based on the consumption rate of the viewer. Such an I/O admission control algorithm may be applied to provide “safe” block replacement that does not cause interruptions to succeeding viewers.

One exemplary I/O admission policy may be advantageously implemented in this role to provide both deterministic quality assurance and optimal utilization of resources available for I/O works, including buffer memory and disk drive I/O capability. Such an admission policy may employ an algorithm that compares the maximal allowable service cycle time (T) required to transmit one cycle of data from buffer memory to all current viewers, with the estimated total service time (T′) for a service cycle of pending I/O requests (i.e., the estimated time required to reload the buffer memory with the next cycle of data to the buffer memory from external storage). Such a comparison of T and T′ may be made to determine whether more viewers may be admitted (i.e., new viewers or existing viewers that have to return to the I/O pool because their intervals are replaced). As long as the estimated minimal T′ for the next service cycle is less than or equal to the current maximal T, then the additional viewers may be admitted. However, if T is greater than estimated T′, then no additional viewers should be admitted, as hiccups to viewers will occur due to the inability of the external storage I/O to keep up. Using this approach to calculate optimal buffer size (i.e., “read-ahead” size) advantageously serves to maximize memory and disk drive utilization. In one example implementation, an algorithm may calculate the maximal allowable service cycle (T) based on the buffer memory available and characteristics of the existing viewers, and may estimate the minimal total service time (T′) for a service cycle of pending I/O requests.

Another consideration is if an interval keeps moving between the cache state and the replaced state, there are two implications: 1) it tends to increase the processing overhead due to the frequent call to the I/O admission control policy; and 2) it tends to complicate the predictability of the system load during the life of any viewer. For example, if a viewer is allowed to keep alternating between the I/O state and the cache state, then the storage processor will have a very hard time to ensure a sufficient resource for all admitted viewers. Thus, several existing viewers may be in the cache state when the I/O admission control policy is invoked for a new viewer and these viewers suddenly forced to return to the external storage I/O state because their intervals are replaced. This represents a surge of IOPS and buffer space demands.

To address the above-described problem, one embodiment of the disclosed memory management structure may be implemented with a policy that only allows a viewer to be assigned into the cache state once. That is, if a data block is to be replaced, its whole interval is to be replaced; and if an interval is replaced, it will never be cached again. Thus, from the point of view of the succeeding viewer of an interval, when it loses its data from the cache, it will continue to be served from external storage until the state of the interval is changed (e.g., due to a VCR control operation).

The above-described policy may be advantageously implemented to stabilize storage processor operation in terms of cache replacement processing and the required I/O admission control and read-ahead calculations. However, various other possible situations exist that may stall the system if not considered and planned for. For example, assume a storage processor is already heavily loaded with full buffer consumption but has some IOPS left. When a new viewer arrives, the I/O admission control policy (e.g., as described above) may decide that the system may take on the new viewer by reducing the read-ahead length. In such a case, at least one cycle of I/O services for the existing viewers in I/O state would be needed to reduce the buffer consumption before sufficient buffer space may be saved for the new viewer. In this regard, a part of the new buffer space may be provided by cache replacement from the free pool Q₁^{free}. However, a problem may exist when cache replacement is not sufficient to supply the required new buffer space. In the event the cache is full and the interval cannot be replaced safely, then the system may become stalled.

In the above described situation, the unavailability of replaceable memory for the free pool Q₁^{free} may cause an internal stall of the resource flow among the memory management structure resource chain of buffer queues Qᵢ^{used}, cache queues Q₁^{free (i>}1), and free pool queue Q₁^{free}. To prevent such an occurrence, a logical mechanism may be implemented by the disclosed memory management structures to push data blocks from the cache queues Qᵢ^{free} (i>1) into the free pool queue Q₁^{free} to maintain a healthy internal flow.

One exemplary embodiment of such a logical mechanism employs a free pool threshold size (e.g., MIN_FREE_POOL) that is associated with free pool queue Q₁^{free} such that if the size of the free pool falls below the free pool threshold size, it triggers or causes the cache/buffer manager to find a cache interval for replacement, in order to make more blocks available for buffer space. In this way, cache replacement is not driven by the introduction of new viewers or the returning existing viewer from the cache state. Instead, the cache replacement is triggered by the threshold size of the free pool and may be generally performed asynchronously.

In one embodiment, a cache replacement policy may be implemented that addresses the above-described concerns in a way that achieves a balance of resource allocation among the external storage I/O capacity, maximum cache memory available, and the maximum buffer memory (plus free pool) in the system design. This balance is implemented to optimize the system capacity in terms of the total number of streams, the total throughput and the playback quality. Further, a healthy internal flow of data blocks is maintained among the cache memory, the buffer memory and the free pool. By employing an I/O admission control policy as described above, a reasonable consumption of the buffer space and the I/O resource may be maintained and thus used to prevent the system from consuming cache memory when free pool capacity is running out.

To summarize this exemplary embodiment, the free pool, Q₁^{free}, may consist of three type of data blocks: a data block that belongs to no movie, a data block that belongs to no interval (i.e., IC=MAX), and a data block that belongs to a replaced interval. Such data blocks in Q₁^{free} may be replaced with new buffer block assignments for a viewer, and are not available for use as cached blocks for other viewers. The free pool, Q₁^{free}, may be associated with a threshold (e.g. MIN_FREE_POOL) expressed in the unit of blocks. If the available data blocks in the free pool falls below the threshold, then one or more cached intervals shall be identified and replaced according to the following free pool threshold-triggered replacement policy implemented.

When the free pool threshold-triggered replacement policy is implemented, a search of the “replaced” intervals starts from the bottom of the Q₂^{free}, moves upward to the top of the Q₂^{free}, continues in the same order in Q₃^{free}, and so on up to the uppermost cache layer queue Q_{K}^{free} if necessary, until a sufficient number of data blocks have been identified for assignment to the free pool such that the free pool has more available data blocks than MIN_FREE_POOL.

When examining a data block and its containing interval for its eligibility as a “replaced” interval to be assigned to the free pool, a criterion may be implemented to ensure that any succeeding viewer may be served from the external storage I/O. If the succeeding viewer is currently served by external storage I/O capacity, then the block and its interval may be replaced without causing a hiccup to the viewer. However, if the succeeding viewer is currently serviced by data from the cache, then the admission control policy of the external storage I/O controller may be consulted to see if there is enough capacity to support the succeeding viewer when it is returning to the I/O state. If such capacity exists, then the data block and its interval is reassigned to the free pool for replacement. However, if such I/O capacity does not exist for a succeeding viewer, the cache/buffer manager continues searching up the cache queues Qᵢ^{free} (i>1) to identify other data blocks that belong to a different interval whose succeeding viewers are currently served by external storage I/O capacity. When identified, these intervals be are reassigned to the free pool Q₁^{free} for replacement.

When a data block is identified for reassignment and replacement as described above, all data blocks that belong to the same interval of the identified data block may be reassigned and made available for replacement. To effect reassignment, the system sets a cache eligibility flag from a CACHE_OK to NO_CACHE state for the preceding viewer of the identified interval so that data blocks already used by the preceding viewer will be assigned to the bottom of free pool Q₁^{free} and thus made available for other viewers. As a result, the succeeding viewer of the same interval will read this data from the external storage for the rest of the life span of this interval, until the interval is redefined due to the state change of either the preceding viewer or the succeeding viewer.

Other issues that may exist and addressed in the operation of the disclosed memory management structure relate to un-predictable user behaviors, such as pause, resume, fast backward and fast-forward. These behaviors may cause the change of a viewer's position in a continuous data stream, such as a movie stream. This behavior may result in a change in the intervals that are formed between given viewers, and in turn results in a change in the caching “value” of data blocks in an interval. Examples of possible changes in intervals include, for example, collapsing of multiple intervals into one interval, disappearance of an interval, and change in interval size.

Referring to FIGS. 2(a), 2(b) and 2(c) again, if a middle viewer V4 of movie #1 of FIG. 2(a) pauses viewing and then resumes viewing after viewer V5 has passed, then the two intervals between viewer V3 and viewer V5 collapse into one. This could also happen if viewer V4 disappears (e.g., terminates, FF, REW, or Pause, etc.). Alternatively, if a middle viewer V4 pauses viewing but resumes viewing before last viewer V5 passes, then the two intervals remain but the interval sizes and costs for the two intervals are altered. An interval may disappear, for example, if first viewer V1 or a last viewer V5 of movie #1 of FIG. 2(a) disappears. An interval length may change, as previously described, when preceding and succeeding viewers of an interval view data blocks with different consumption rates.

To handle changes in intervals caused by unpredictable user behaviors, the policies disclosed herein may be adopted in the implementation of the disclosed memory management structures. As previously described, when a block is reassigned from a buffer layer queue to a cache layer queue, the instantaneous values of FVC and IC are calculated and are used to decide the initial positioning of the block, e.g. in combination with associated MIC values of each cache layer queue. Various blocks in a given interval may be placed into different cache queues if their associated FVC and IC values are different. This means that the sorting and the relative prioritization (based on their associated “value”) are in the finer granularity of block (or a segment of block) level. Therefore, if the value of the interval changes, its data blocks are placed accordingly. Thus, the disclosed structures may be implemented in a manner that relies on internal “competition” among cached data blocks to macro-manage, instead of micro-manage, the unpredictable and help ensure overall fairness and intelligence in cache management decisions when unpredictable behavior occurs.

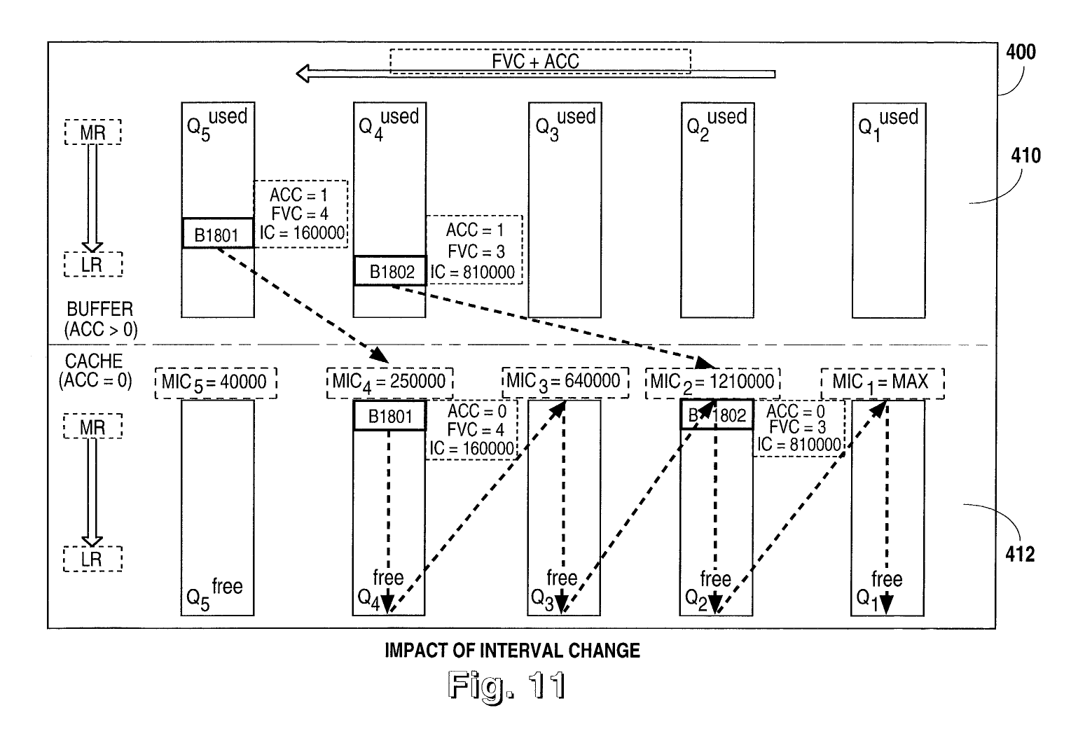

Returning to FIGS. 2(a), 2(b), 2(c) and the memory management structure of FIG. 7 to illustrate this point, data blocks in the interval between blocks 1401 and blocks 1801 may be placed in the cache as shown and described in relation to FIG. 7. However, if as illustrated in FIG. 10, viewer V2 pauses when viewer V1 is consuming block 1802 then block 1802 and those following will be assigned differently because the FVC value and the IC values are different, as shown in FIG. 11. Although it is possible to implement an alternative management structure so that blocks 1801 and following blocks of the original interval between viewers V1 and V2 of FIG. 10 are moved to the same lower priority queue in such a situation, this is not necessary. Other data blocks will push the block assignments for these blocks down the cache layer structure anyway, and thus the complexity and computational overhead may be avoided by allowing reassignment according to FIG. 11.

### EXAMPLES

The following examples are illustrative and should not be construed as limiting the scope of the invention or claims thereof.

### Example 1

### Caching Implementation Considerations

The following are exemplary and illustrative considerations that may be implemented, in whole or in part, in the practice of one embodiment of the disclosed methods and systems described herein. It will be understood that these considerations are optional and it is not necessary that any of these considerations be implemented to successfully practice the disclosed methods and systems.

1) If the total available memory for a storage processor is 1.5 GB, then the cache memory may be set between 0.55 GB to 0.7 GB, with a default of 0.6 GB. This amount of memory will be shared by Q₂^{free}, Q₃^{free}, and up to Qₖ^{free}. This is to say that 40% of the memory is used for the caching and 60% are used for the buffering (and free pool).

2) For the buffering space, a minimal free pool level may be maintained in order to prevent an internal stall of the resource flow. For example, MIN_FREE_POOL may be set to be the size of memory that is large enough for two read-ahead buffers of about 3˜4% of viewers served by external disk drives. Therefore its setting depends on the application environment. In a run time environment where majority of the clients have 3 mbps bandwidth, MIN_FREE_POOL may be set at about 82 MB. On the other hand, in a run time environment where majority of clients have about 20 kbps bandwidth, the MIN_FREE_POOL may be set at about 12.5 MB. Therefore, the range for the MIN_FREE_POOL may be about 10 MB˜85 MB and the default be 25 MB.

3) The number of cache queues allocated may be determined based on a balance between two contending facts: 1) more queues will provide a finer differentiation among popular videos; however 2) more queues will present a challenge to guarantee high utilization of every queue. In one embodiment, the following settings may be employed: the number of queues (the value of K) may range from 4 to 10, depending on the application environment. If the majority of the clients have bandwidth higher than about 1 mbps, then K is set to 4. If the majority of the clients have bandwidth in the range of about 100 mbps , then K is set to 7. If the majority of the clients have low bandwidth, then K is set to 10.

4) In one embodiment, the MIC values may be set for each cache queue based as using the following formula:

MIC(K−j)=(j+1)*M where 0<=j <=K−2 (2)

By using this formula, the configuration for the MIC values may be reduced to one single parameter—the base value M. In one embodiment, the range for M may be between about 1600² to about 3200² when IC calculated by formula (1), and between about 1600 and about 3200 is IC is calculated by formula (1′). Again, is the client bandwidth is high in general, then M may be selected larger.

While the invention may be asaptable to various modifications and alternative forms, specific embodiments have been shown by way of example and described herein. However, it should be understood that the invetnion is not intended to be limited to the particular forms disclosed. Rather, the invention is to cover all modifications, equivalents, and alternatives falling within the spirit and scope of the invention as defined by the appended claims. Moreover, the different aspects of the desclosed apparatus and methods may be utilized in various combinations and/or independently. Thus the invention is not limited to only those combinations shown herein, but rather may include other combinations.

What is claimed is:

1. A method of managing memory units, comprising assigning a memory unit of an oversize data object to one of two or more memory positions based on a status of at least one first memory parameter that reflects the number of anticipated future requests for access to said memory unit, the elapsed time until receipt of a future request for access to said memory unit, or a combination thereof.

2. The method of claim 1, wherein said assigning comprises assigning said memory unit to a first memory position based on a first status of said at least one first memory parameter; and reassigning said memory unit to a second memory position based on a second status of said at least one memory parameter, said first status of said memory parameter being different than said second status of said memory parameter.

3. The method of claim 2, wherein said first memory position comprises a position within a first memory queue, and wherein said second memory position comprises a position within a second memory queue.

4. The method of claim 2, wherein said first memory position comprises a first position within said buffer memory, and wherein said second memory position comprises a second position within said buffer memory.

5. The method of claim 2, wherein said first memory position comprises a position within a first buffer memory queue, and wherein said second memory position comprises a position within a second buffer memory queue.

6. The method of claim 1, wherein said assigning is also based on a status of at least one second memory parameter that reflects the number of memory units existing in the data interval between an existing viewer of said memory unit and a succeeding viewer of said memory unit, the difference in data consumption rate between said existing viewer and said succeeding viewer of said memory unit, or a combination thereof.

7. The method of claim 2, wherein said reassigning is also based on a status of at least one second memory parameter that reflects the number of memory units existing in the data interval between an existing viewer of said memory unit and a succeeding viewer of said memory unit, the difference in data consumption rate between said existing viewer and said succeeding viewer of said memory unit, or a combination thereof.

8. The method of claim 7, wherein said first memory position comprises a position within a buffer memory, and wherein said second memory position comprises a position within a cache memory or a free pool memory.

9. The method of claim 8, wherein initiation of said assignment between said first memory position and said second memory position is based on said status of said first parameter; and wherein said relative location of said second memory position within cache memory or free pool memory is based on said status of said second memory parameter.

10. The method of claim 9, wherein said first memory position comprises a position within a buffer memory queue, and wherein said second memory position comprises a position within a cache memory queue or a free pool memory queue.

11. The method of claim 1, wherein said two or more memory positions comprise at least two positions within a buffer memory; and wherein said at least one first memory parameter comprises a succeeding viewer count (FVC).

12. The method of claim 7, wherein said two or more memory positions comprise at least one position within a buffer memory and at least one position in a cache memory, and wherein said at least one first memory parameter comprises an active connection count (ACC), a succeeding viewer count (FVC) or a combination thereof; and wherein said at least one second memory parameter comprises an interval cost (IC).

13. The method of claim 9, wherein said two or more memory positions comprise at least one position within a buffer memory, at least one position in a cache memory, and at least position in a free pool memory; and wherein said at least one first memory parameter comprises an active connection count (ACC), a succeeding viewer count (FVC) or a combination thereof; and wherein said at least one second memory parameter comprises an interval cost (IC).

14. The method of claim 1, wherein said method further comprises assigning said memory unit to said one of two or more memory positions based at least partially on the status of a flag associated with said memory unit.

15. The method of claim 14, wherein said flag represents a priority class associated with said memory unit.

16. The method of claim 1, wherein said memory units comprise memory blocks.

17. The method of claim 1, wherein said over-size data object comprises continuous media data.

18. The method of claim 1, wherein said over-size data object comprises non-continuous data.

19. A method of managing memory units within an information delivery environment, comprising assigning a memory unit of an over-size data object to one of a plurality of memory positions based on a status of at least one first memory parameter and a status of at least one second memory parameter; said first memory parameter reflecting the number of anticipated future requests for access to said memory unit, the elapsed time until receipt of a future request for access to said memory unit, or a combination thereof; and said second memory parameter reflecting the number of memory units existing in the data interval between an existing viewer of said memory unit and a succeeding viewer of said memory unit, the difference in data consumption rate between said existing viewer and said succeeding viewer of said memory unit, or a combination thereof.

20. The method of claim 19, wherein said plurality of memory positions comprise at least two positions within a buffer memory and at least two positions within a cache memory, each of said two positions in said cache memory corresponding to a respective one of said two positions within said buffer memory.

21. The method of claim 20, wherein said buffer memory comprises a plurality of positions, each buffer memory position having a sequential identification value associated with said buffer memory position, and wherein said cache memory comprises a plurality of positions, each cache memory position having a sequential identification value associated with said cache memory position that correlates to a sequential identification value of a corresponding buffer memory position, each of said sequential identification values corresponding to a possible sum of active connection count (ACC) and succeeding viewer count (FVC) or range thereof that may be associated with a memory unit at a given time; and
wherein if said active connection count number is greater than zero, said assigning comprises assigning said memory unit to a first buffer memory position that has a sequential identification value corresponding to the sum of active connection count (ACC) and succeeding viewer count (FVC) associated with said memory unit; and wherein said method further comprises leaving said memory unit in said first buffer memory position until a subsequent change in the sum of active connection count (ACC) and succeeding viewer count (FVC) associated with said memory unit, and reassigning said memory unit as follows upon a subsequent change in active connection count (ACC) or the sum of active connection count (ACC) and succeeding viewer count (FVC) associated with said memory unit:
if said sum of active connection count (ACC) and succeeding viewer count (FVC) increases to a number corresponding to a sequential identification value of a second buffer memory position, then reassigning said memory unit from said first buffer memory position to said second buffer memory position;
if said sum of active connection count (ACC) and succeeding viewer count (FVC) increases to a number corresponding to the same sequential identification value of said first buffer memory position, or decreases to a number that is greater than or equal to one, then leaving said memory unit in said first buffer memory position; or
if said active connection count (ACC) decreases to zero, then reassigning said memory unit from said first buffer memory position to a first cache memory position that has a sequential identification value that correlates to the sequential identification value of said first buffer memory position, or that has a sequential identification value that correlates to the sequential identification value of a buffer memory position having a lower sequential identification value than said first buffer memory position.

22. The method of claim 21, wherein a sequentially higher maximum interval cost (MIC) is associated with each sequentially lower cache memory position; and wherein when said active connection count (ACC) decreases to zero said method further comprises comparing an interval cost (IC) associated with said memory unit with a maximum interval cost (MIC) associated with a cache memory position that has a sequential identification value that correlates to the sequential identification value of said first buffer memory position; and
reassigning said memory unit from said first buffer memory position to a first cache memory position that comprises a cache memory position having a sequential identification value that correlates to the sequential identification value of said first buffer memory position if said interval cost (IC) associated with said memory unit is less than or equal to said maximum interval cost (MIC) associated with said cache memory position; or
reassigning said memory unit from said first buffer memory position to a first cache memory position that is the sequentially highest cache memory position having an associated maximum interval cost (MIC) greater than said interval cost (IC) of said memory unit if said interval cost (IC) associated with said memory unit is greater than said maximum interval cost (MIC) of said cache memory position having a sequential identification value that correlates to the sequential identification value of said first buffer memory position.

23. The method of claim 22, further comprising reassigning said memory unit from said first cache memory position in a manner as follows:
if said active connection count number (ACC) increases from zero to a number greater than zero, then reassigning said memory unit from said first cache memory position to a buffer memory position that has a sequential identification value corresponding to the sum of active connection count (ACC) and succeeding viewer count (FVC) associated with said memory unit; or
if said number of current active connection count (ACC) remains equal to zero, then subsequently reassigning said memory unit to a cache memory position having one lower sequential identification value than the sequential identification value associated with said first cache memory position, or removing said memory unit from said cache memory if said first cache memory position is associated with the lowermost sequential identification value.

24. The method of claim 23, wherein said over-size data object comprises continuous media data; and wherein prior to removing said memory unit from said cache memory, said method further comprises using an external storage I/O admission policy to determine if sufficient external storage I/O capacity exists to serve succeeding viewers of said memory unit without interruption; and further comprises maintaining said memory unit in buffer/cache memory if said sufficient external storage I/O capacity does not exist.

25. The method of claim 23, wherein said over-size data object comprises continuous media data; and wherein said method further comprises maintaining a threshold size of memory allocated to memory units assigned to said cache memory position associated with the lowermost sequential identification value by identifying and reassigning memory units from other cache memory positions having higher sequential identification values as needed to maintain said threshold memory size.

26. The method of claim 22, wherein each buffer memory position and each cache memory position comprises an LRU queue.

27. The method of claim 23, wherein each buffer memory position comprises an LRU buffer queue having a flexible size; and wherein the cache memory position having the lowermost sequential identification value comprises an LRU free pool queue having a flexible size; wherein each cache memory position having a sequential identification value greater than the lowermost sequential identification value comprises an LRU cache queue having a fixed size, with the total memory size represented by said LRU buffer queues, said LRU cache queues and said LRU free pool being equal to a total memory size of a buffer/cache memory; and
wherein said reassignment of said memory unit from said first cache memory position to a cache memory position having one lower sequential identification value occurs due to LRU queue displacement to the bottom and out of said respective fixed size LRU cache queue; and
wherein said removal of said memory unit from said cache memory position having the lowermost sequential identification value occurs due to LRU queue displacement of said memory unit to the bottom of said LRU free pool queue and subsequent reuse of buffer/cache memory associated with said memory unit at the bottom of said flexible LRU free pool queue for a new memory unit assigned from external storage to a buffer memory position.

28. The method of claim 27, wherein said over-size data object comprises continuous media data; and wherein prior to reassigning said memory unit to said LRU free pool queue, said method further comprises using an external storage I/O admission policy to determine if sufficient external storage I/O capacity exists to serve succeeding viewers of said memory unit without interruption; and further comprises maintaining said memory unit in buffer/cache memory if said sufficient external storage I/O capacity does not exist.

29. The method of claim 27, wherein said over-size data object comprises continuous media data; and wherein said method farther comprises maintaining a threshold size of memory allocated to memory units assigned to said LRU free pool queue by identifying and reassigning memory units from other LRU cache queues to said LRU free pool queue as needed to maintain said threshold memory size.

30. The method of claim 19, wherein said assignment of said memory units is managed and tracked by a processor or group of processors in an integrated manner.

31. The method of claim 19, wherein said assignment and reassignment of said memory units is managed using identifier manipulation.

32. The method of claim 27, wherein said assignment of said memory units is managed and tracked by a processor or group of processors in an integrated manner.

33. The method of claim 27, wherein said assignment and reassignment of said memory units is managed using identifier manipulation.

34. The method of claim 20, wherein said method further comprises assigning said memory unit to said one of a plurality of memory positions based at least partially on the status of said flag associated with said memory unit.

35. The method of claim 34, wherein said flag represents a priority class associated with said memory unit.

36. The method of claim 19, wherein said memory units comprise memory blocks.

37. The method of claim 19, wherein said over-size data object comprises continuous media data.

38. The method of claim 19, wherein said over-size data object comprises non-continuous data.

39. A method of managing memory units using an integrated memory management structure, comprising:
assigning memory units of an over-size data object to one or more positions within a buffer memory defined by said integrated structure;
subsequently reassigning said memory units from said buffer memory to one or more positions within a cache memory defined by said structure or to a free pool memory defined by said structure; and
subsequently removing said memory units from assignment to a position within said free pool memory;
wherein said reassignment of said memory units from said buffer memory to one or more positions within said cache memory is based on the combination of at least one first memory parameter and at least one second memory parameter, wherein said first memory parameter reflects the value of maintaining said memory units within said cache memory in terms of future external storage I/O requests that may be eliminated by maintaining said memory units in said cache memory, and wherein said second memory parameter reflects cost of maintaining said memory units within said cache memory in terms of the size of said memory units and duration of storage associated with maintaining said memory units within said cache memory.

40. The method of claim 39, wherein said assignment and reassignment of said memory units is managed and tracked by a processor or group of processors in an integrated manner.

41. The method of claim 39, wherein said assignment and reassignment of said memory units is managed using identifier manipulation.

42. The method of claim 39, wherein said assignment of said memory units to one or more positions within a buffer memory is based at least in part on a status of at least one first memory parameter that reflects the number of anticipated future requests for access to said memory units.

43. The method of claim 39, wherein said subsequent reassignment said memory units from said buffer memory to one or more positions within a cache memory or free pool memory is based at least in part on the number of memory units existing in the data interval between an existing viewer of said memory units and a succeeding viewer of said memory units, the difference in data consumption rate between said existing viewer and said succeeding viewer of said memory units, or a combination thereof.

44. The method of claim 39, wherein said subsequent removal of said memory units from assignment to a position within said free pool memory occurs to accommodate assignment of new memory units from external storage to a buffer memory position.

45. The method of claim 39, wherein said over-size data object comprises continuous media data: and wherein prior to removing said memory unit from assignment to said free pool memory, said method further comprises using an external storage I/O admission policy to determine if sufficient external storage I/O capacity exists to serve succeeding viewers of said memory unit without interruption; and further comprises maintaining said memory unit in buffer/cache memory if said sufficient external storage I/O capacity does not exist.

46. The method of claim 39, further comprising making one or more of the following reassignments of said memory units within said structure prior to removal of said memory units from said free pool:
reassigning said memory units between multiple positions within said buffer memory; or
reassigning said memory units from said cache memory or from said free pool memory to one or more positions within said buffer memory; or
reassigning said memory units between multiple positions within said cache memory; or
reassigning said memory units between said cache memory and said free pool memory; and
wherein said reassignments of said memory units is based at least in part on said first and second memory parameters.

47. The method of claim 46, wherein said assignment or said reassignment of said memory units to one or more positions within a buffer memory is based at least in part on a status of at least one first memory parameter that reflects the number of anticipated future requests for access to said memory unit;
wherein reassignment of said memory units from said buffer memory to one or more positions within a cache memory or free pool memory is based at least in part on the number of memory units existing in the data interval between an existing viewer of said memory unit and a succeeding viewer of said memory unit, the difference in data consumption rate between said existing viewer and said succeeding viewer of said memory unit, or a combination thereof; and
wherein said subsequent removal of said memory units from assignment to a position within said free pool memory occurs to accommodate assignment of a new memory unit from external storage to a buffer memory position.

48. The method of claim 47, wherein said over-size data object comprises continuous media data; and wherein prior to removing said memory unit from assignment to said free pool memory, said method further comprises using an external storage I/O admission policy to determine if sufficient external storage I/O capacity exists to serve succeeding viewers of said memory unit without interruption; and further comprises maintaining said memory unit in buffer/cache memory if said sufficient external storage I/O capacity does not exist.

49. The method of claim 47, wherein initial assignment of said memory units from external storage to said buffer memory is made based on occurrence of an active connection associated with said memory units; wherein said reassignment of said memory units from said buffer memory to said cache memory or said free pool memory is made on occurrence of decrementation of said active connection count (ACC) to a value less than zero; and wherein said reassignment of said memory units from said cache memory or said free pool memory to said buffer memory is made on occurrence of incrementation of said active connection count (ACC) to a value greater than zero.

50. The method of claim 49, wherein said active connection count (ACC) associated with each memory unit is tracked by said processor or group of processors; and wherein said processor or group of processors manages said assignment and reassignment of said memory units in an integrated manner based at least partially thereon.

51. The method of claim 49, wherein said buffer memory comprises two or more sequentially ascending buffer memory queues, wherein said free pool memory comprises at least one free pool memory queue corresponding to the lowermost of said sequentially ascending buffer queues, and wherein said cache memory comprises at least one cache memory queue corresponding to another of said buffer memory queues; and wherein said method further compnses:
assigning and reassigning memory units between the queues of said buffer memory based at least in part on the succeeding viewer count (FVC) associated with said memory units;
reassigning memory units between said buffer memory and said cache or free pool memories based at least in part on the interval cost (IC) associated with said memory units;
assigning and reassigning memory units between the queues of said cache memory and said free pool memory based on the relative frequency of requests for access to a given memory unit; and
removing said memory units from said free pool memory based on relative recency of requests for access to a given memory unit and need for additional memory for use by said buffer memory.

52. The method of claim 51, wherein said reassignment of said memory units from said buffer memory to said cache memory or free pool memory occurs from a buffer memory queue to a corresponding or sequentially lower cache memory queue or free pool memory queue; wherein said reassignment of said memory units from said cache memory or said free pool memory to said buffer memory occurs from a cache memory queue or free pool memory queue to a corresponding or higher buffer memory queue.

53. The method of claim 52, wherein said reassignment of said memory units from said buffer memory to said cache memory or free pool memory occurs from a buffer memory queue to a corresponding or sequentially lower cache memory queue or free pool memory queue that is the sequentially highest cache memory or free pool queue being a having maximum interval cost (MIC) that is greater than or equal to the interval cost (IC) associated with said memory units; and wherein said reassignment of said memory units from said cache memory or said free pool memory to said buffer memory occurs from a cache memory queue or free pool memory queue to a corresponding or higher buffer memory queue.

54. The method of claim 52, wherein said reassignment of said memory units between said buffer memory queues occurs from a lower buffer memory queue to a higher sequentially ascending buffer memory queue; wherein reassignment of said memory units between said cache memory queues occurs from a higher sequentially ascending cache memory queue to a lower cache memory queue or free pool memory queue.

55. The method of claim 54, wherein each said buffer memory queue, cache memory queue and free pool memory queue comprises an LRU queue; wherein each said cache memory queue has a fixed size; and wherein a reassignment of said memory units from the bottom of a higher sequentially ascending cache LRU memory queue to a lower cache LRU memory queue or free pool LRU memory queue occurs due to assignment of other memory units to the top of said higher sequential ascending cache LRU memory queue.

56. The method of claim 55, wherein each said buffer memory queue and said free pool memory queue are flexible in size and share the balance of the memory not used by said cache memory queues; and wherein a removal of said memory units occurs from the bottom of said free pool LRU memory queue to transfer free memory space to one or more of said buffer memory queues to provide sufficient space for assignment of new memory units from external storage to one or more of said buffer memory queues.

57. A method of managing memory units memory units of an over-size data object using a multi-dimensional logical memory management structure, comprising:
providing two or more spatially-offset organizational sub-structures, said substructures being spatially offset in symmetric or asymmetric spatial relationship to form said multi-dimensional management structure, each of said sub-structures having one or more memory unit positions defined therein; and
assigning and reassigning memory units memory units of an over-size data object between memory unit positions located in different organizational sub-structures, between positions located within the same organizational sub-structure, or a combination thereof;
wherein said assigning and reassigning of memory units memory units of an over-size data object within said structure is based on multiple memory state parameters.

58. The method of claim 57, wherein said spatially offset organization structures comprise two or more spatially-offset rows, columns, layers, queues, or any combination thereof.

59. The method of claim 57, wherein one or more of said spatially-offset organizational substructures are subdivided into two or more positions within the substructure, said positions being organized within the substructure in a sequentially ascending or descending manner.

60. The method of claim 57, wherein said assignments and reassignments of a memory unit within said multi-dimensional structure results in mapping a relative positioning of said memory unit that reflects an updated cache value of said memory unit relative to other memory units in said structure in terms of said multiple memory state parameters.

61. A method of managing memory units using an integrated two-dimensional logical memory management structure, comprising:
providing a first horizontal buffer memory layer comprising two or more sequentially ascending buffer memory positions;
providing a first horizontal cache memory layer comprising one or more sequentially ascending cache memory positions and a lowermost memory position that comprises a free pool memory position, said first horizontal cache memory layer being vertically offset from said first horizontal buffer memory layer;
horizontally assigning and reassigning memory units of an over-size data object between said buffer memory positions within said first horizontal buffer memory layer based on at least one first memory parameter;
horizontally assigning and reassigning memory units of an over-size data object between said cache memory positions and between said free pool memory position within said first horizontal cache memory layer based on at least one second memory parameter; and
vertically assigning and reassigning memory units of an over-size data object between said first horizontal buffer memory layer and said first horizontal cache memory layer based on at least one third memory parameter.

62. The method of claim 61, wherein reassignment of a memory unit from a first position to a second position within said structure is based on relative positioning of said first position within said structure and on said first and second parameters; and wherein said relative positioning of said second position within said structure reflects a renewed cache value of said memory units relative to other memory units in the structure in terms of at least two of said first, second and third parameters.

63. The method of claim 61, wherein each of said vertical and horizontal assignments and reassignments of a memory unit within said two-dimensional structure results in mapping a relative positioning of said memory unit that reflects an updated cache value of said memory unit relative to other memory units in said structure in terms of at least two of said first, second and third parameters without requiring individual values of said parameters to be explicitly recorded and recalculated.

64. The method of claim 61, wherein each of said vertical and horizontal assignments and reassignments of a memory unit within said two-dimensional structure results in mapping a relative positioning of said memory unit that reflects an updated relative cache value of said memory unit relative to other memory units in said structure in terms of at least two of said first, second and third parameters, and that allows removal of memory units having the least relative cache value in terms of at least two of said first, second and third parameters, without requiring individual values of said parameters to be explicitly recalculated and resorted.

65. The method of claim 61, wherein said first memory parameter comprises a frequency parameter, wherein said second memory parameter comprises a recency parameter, and wherein said third parameter comprises a connection status parameter.

66. The method of claim 65, wherein each said buffer memory position comprises a buffer memory queue; wherein each said cache memory position comprises a cache memory queue; and wherein intra-queue positioning occurs within each buffer memory queue based on a fourth memory parameter; and wherein intra-queue positioning with each cache memory queue and free pool memory queue occurs based on a fifth memory parameter.

67. The method of claim 66, wherein said fourth and fifth memory parameters comprise recency parameters.

68. The method of claim 67, wherein said each buffer memory queue, cache memory queue and free pool memory queue comprise LRU memory queues.

69. The method of claim 68, further comprising:
horizontally assigning and reassigning memory units between said buffer memory queues within said first horizontal buffer memory layer based at least in part on a value parameter that reflects the value of maintaining said memory units within said cache memory in terms of future external storage I/O requests that may be eliminated by maintaining said memory units in said buffer/cache memory;
vertically reassigning memory units between said buffer memory queues and said cache or free pool memory queues based at least in part on a recency parameter that reflects the status of active requests for access to a given memory unit, and on a cost parameter that reflects the value of maintaining said memory units within said cache memory in terms of future external storage I/O requests that may be eliminated by maintaining said memory units in said buffer/cache memory, and reflects the cost of maintaining said memory units within said cache memory in terms of the size of said memory units and duration of storage associated with maintaining said memory units within said cache memory;
horizontally assigning and reassigning memory units between said cache memory queues and said free pool memory queues based at least in part on the relative recency of requests for access to a given memory unit; and
removing said memory units from said free pool memory queue based on relative recency of requests for access to a given memory unit and need for additional memory for use by said buffer memory.

70. The method of claim 61, wherein said assignments and reassignments are managed and tracked by a processor or group of processors in an integrated manner.

71. The method of claim 61, wherein said assignment and reassignment of said memory units is managed using identifier manipulation.

72. The method of claim 61, further comprising:
providing a second horizontal buffer memory layer comprising two or more sequentially ascending buffer memory positions, said second horizontal buffer memory layer being vertically offset from said first horizontal buffer memory layer; or providing a second horizontal cache memory layer comprising two or more sequentially ascending buffer memory positions, said second horizontal buffer memory layer being vertically offset from said first horizontal cache memory layer;
horizontally assigning and reassigning memory units between said memory positions within said second horizontal buffer memory layer or said second horizontal cache memory layer based on at least one sixth memory parameter; and
vertically assigning and reassigning memory units between said second horizontal buffer memory layer or said second horizontal cache memory layer and said first horizontal buffer memory layer or said first horizontal cache memory layer based on at least one seventh memory parameter.

73. An integrated two-dimensional logical memory management structure for use in managing memory units of over-size data objects, comprising:
at least one horizontal buffer memory layer comprising two or more sequentially ascending continuous media data buffer memory positions; and
at least one horizontal cache memory layer comprising one or more sequentially ascending over-size data object memory unit cache memory positions and a lowermost memory position that comprises an over-size data object memory unit free pool memory position, said first horizontal cache memory layer being vertically offset from said first horizontal buffer memory layer.

74. The memory management structure of claim 73, wherein said each of said sequentially ascending cache memory positions and said free pool memory position uniquely correlates to one of said sequentially ascending buffer memory positions.

75. The memory management structure of claim 73, wherein memory units of said over-size data object are operably assignable, reassignable and trackable between each of said buffer memory positions, cache memory positions and said free pool memory position by a processor or group of processors in an integrated manner.

76. The memory management structure of claim 75, wherein said memory units are operably placeable within each of said buffer memory positions, cache memory positions or said free pool memory position using identifier manipulation.

77. A method for managing over-size data object content in a network environment comprising:
determining the number of active connections and anticipated future connections associated with said over-size data object content used within the network environment; and
referencing the content location based on the determined connections and anticipated future connections.

78. The method of claim 73, further comprising:
obtaining the content from an external storage device operably coupled to the network environment;
referencing the content into an available used memory reference corresponding to the sum of active connections and anticipated future connections.

79. The method of claim 77, further comprising:
locating the content in a free memory reference; and
referencing the content using an available used memory reference in response to determining the existence of an active connection status.

80. The method of claim 79, further comprising determining an interval cost (IC) parameter associated with the content upon referencing the content.

81. The method of claim 77, further comprising determining a maximum interval cost (MIC) parameter value operable to reduce a cost of maintaining content in free memory.

82. The method of claim 81, further comprising:
determining a closure of all active connections associated with said over-size data object data;
comparing the maximum interval cost (MIC) parameter to the interval cost (IC) parameter; and
performing an action in response to comparing the maximum interval cost (MIC) parameter to the interval cost (IC) parameter.

83. The method of claim 82, further comprising re-referencing the content to a first free memory reference upon determining an interval cost (IC) parameter value that is less than or equal to the maximum interval cost (MIC) parameter value.

84. The method of claim 83, further comprising:
re-referencing the content to a second free memory reference upon determining an interval cost (IC) parameter value that is greater than the maximum interval cost (MIC) parameter value associated with the first free memory reference.

85. The method as recited in claim 77, further comprising:
detecting a closed connection associated with accessing the content;
determining the reference associated with the content; and
decrementing a count value associated with the content in response to the closed connection.

86. The method of claim 85, further comprising:
determining the count value associated with the content; and
re-referencing the content in response to determining count value equal to zero.

87. A network processing system operable to process information communicated via a network in an over-size data object environment comprising:
a network processor operable to process network communicated information in said oversize data object environment; and
a memory management system operable to reference the information based upon a connection status, number of anticipated future connections, and cache storage cost associated with the information.

88. The system of claim 87, wherein the memory management system comprises:
a first used memory reference operable to reference the information in response to determining an active connection status; and
a second free memory reference operably associated with the first used memory reference and operable to provide a reference to the content in response to determining the active connection status.

89. The system of claim 88, further comprising:
a second used memory reference logically coupled to the first used memory reference and the first free memory reference; and
a second free memory reference logically coupled to the second used memory reference and the first free memory reference.

90. The system of claim 89, further comprising the second used memory reference operable to reference content referenced by the first used memory reference and the first free memory reference based upon a parameter associated with the content.

91. The system of claim 89, further comprising the second free memory reference operable to reference content referenced by the second used memory reference based on a connection status associated with the content.

92. The system of claim 89, further comprising the second free memory reference operable to provide a reference to the content to the first free memory reference based upon a parameter association with the content.

93. The system of claim 87, further comprising the memory operable to reference content based on a cache value parameter associated with the information.

94. The system of claim 87, further comprising the memory operable to reference content based on a cache storage cost parameter associated with one or more memory references.

95. A method for managing over-size data object content within a network environment comprising:
determining the number of active connections and anticipated future connections associated with said over-size data object content used within the network environment;
referencing the content based on the determined active and anticipated connections;
locating the content in a memory; and re-referencing the content using and available free memory reference upon detecting closure of all active connections.
